(19) United States
(12) Patent Application Publication
(10) Pub. No.: US 2024/0383401 A1
(43) Pub. Date: Nov. 21, 2024

(54) AUTONOMOUS AND SEMI-AUTONOMOUS OFF-ROAD VEHICLE CONTROL

(71) Applicant: Polaris Industries Inc., Medina, MN (US)

(72) Inventors: Aidan Shaughnessy, Overland Park, KS (US); Eric Fuchs, Wyoming, MN (US); Forrest Johnson, Stacy, MN (US); Chiao George Liu, White Bear Lake, MN (US); Scott Taylor, Blaine, MN (US); Timothy Norstad, Turtle Lake, WI (US); Eric Ross, Howell, MI (US); Kevin Dunn, Fenton, MI (US); Jonathon Graus, Stacy, MN (US); Brian Krosschell, North Branch, MN (US); Benjamin Betcher, Shakopee, MN (US); Jon Hetland, Lino Lakes, MN (US); Joseph Bauer, Lindstrom, MN (US); Vinay Shirodkar, Bangalore (IN)

(21) Appl. No.: 18/663,347

(22) Filed: May 14, 2024

Related U.S. Application Data
(60) Provisional application No. 63/466,485, filed on May 15, 2023.
(60) Provisional application No. 63/518,696, filed on Aug. 10, 2023.

(51) Int. Cl. B60Q 9/00; G01C 21/00

(52) U.S. Cl. CPC B60Q 9/00; G01C 21/005

(57) ABSTRACT

A method of detecting and warning an operator of an off-road vehicle of objects in limited-visibility environments. The method includes: detecting a potentially-hazardous object within the vicinity of the vehicle, using a sensor of the vehicle; transmitting data relating to the potentially-hazardous object to a vehicle processor; determining whether the potentially-hazardous object is in a projected path of the vehicle or in a proximity zone of the vehicle; and alerting the operator of the vehicle to the presence and location of the potentially-hazardous object when the potentially-hazardous object is in the projected path of the vehicle or in the proximity zone of the vehicle.

### CROSS REFERENCE TO RELATED APPLICATIONS

This application claims the benefit of U.S. Provisional Application No. 63/466,485, filed on May 15, 2023, 2023 and U.S. Provisional Application No. 63/518,696, filed on Aug. 10, 2023, entitled AUTONOMOUS AND SEMI-AUTONOMOUS OFF-ROAD VEHICLE CONTROL, the entire contents of which are expressly incorporated by reference herein.

### BACKGROUND

Owners and operators of off-road vehicles, including side-by-side vehicles, all-terrain vehicles, off-road utility vehicles, snowmobiles and other such vehicles, primarily operate such vehicles in and on areas off of highways and roads. With the widespread growth in the large variety of types of vehicles and their utility, off-road vehicles may be operated for many different purposes, including recreation, utility and even general transportation. As a result, operators of off-road vehicles may find themselves in a variety of situations where automated assistance from the off-road vehicle itself could be helpful and even safety enhancing.

### SUMMARY

Embodiments of the present disclosure various systems, devices and methods for controlling off-road vehicles and for assisting and alerting operators to surrounding conditions and other vehicles.

One embodiment of the present disclosure is a method for autonomously loading an off-road vehicle having a vehicle controller in communication with a vehicle sensor, a plurality of vehicle operating systems and a human-machine interface, onto a platform of a transport vehicle.

In an embodiment, the method includes: detecting a loading ramp associated with the transport vehicle using the vehicle sensor; determining whether the off-road vehicle will fit onto the loading ramp based on data provided by the vehicle sensor; determining an inclination angle of the loading ramp relative to the vehicle platform; and controlling one of the plurality of vehicle operating systems using the vehicle controller to cause the vehicle to accelerate up the loading ramp.

Another embodiment of the present disclosure is a method for autonomously unloading an off-road vehicle having a vehicle controller in communication with a vehicle sensor, a plurality of vehicle operating systems and a human-machine interface, from a platform of a transport vehicle. In an embodiment, the method includes: detecting a loading ramp associated with the transport vehicle using the vehicle sensor; determining whether the ORV will fit onto the loading ramp based on data provided by the vehicle sensor; determining an inclination angle of the loading ramp relative to the vehicle platform; and controlling one of the plurality of vehicle operating systems using the vehicle controller to cause the vehicle to accelerate down the loading ramp.

Another embodiment of the present disclosure is a method for autonomously parking an off-road vehicle having a vehicle controller in communication with a vehicle sensor, a plurality of vehicle operating systems and a human-machine interface, onto a transport vehicle. In an embodiment, the method includes: visually detecting using an image located on the transport vehicle using the vehicle sensor, the image including information corresponding to a docking location of the vehicle on the transport vehicle; transmitting image data from the vehicle sensor to the vehicle controller; processing the image data to determine the information corresponding to the docking location using the vehicle controller, including determining a predetermined docking distance of the vehicle to the detected image; controlling operation of the vehicle causing the vehicle to move from an initial position toward a docked position; determining that the vehicle is located at the docked position and at the predetermined docking distance from the detected image; and controlling a braking system of the vehicle to cause the vehicle to stop at the docked position.

Another embodiment of the present disclosure is a method of controlling a vehicle using operator gestures. In an embodiment, the method includes: capturing multiple images of a vicinity around the vehicle using an image-capturing sensor of the vehicle; transmitting the image data of the multiple images from the image-capturing sensor of the vehicle to a computer processor associated with the vehicle; analyzing the image data of the multiple received images from the image-capturing sensor of the vehicle to detect whether an operator of the vehicle is making vehicle-control gestures; associating the detected vehicle-control gesture with a vehicle-control command; and causing the vehicle to execute the vehicle-control command associated with the detected vehicle-control gesture.

Another embodiment of the present disclosure is a method of autonomously controlling a vehicle using a remote-control device. In an embodiment, the method includes: receiving a first communication signal from the remote-control device at a sensor of the vehicle; detecting a location of the remote-control device relative to a location of the vehicle based on the first communication signal received from the remote-control device; causing a graphical user interface (GUI) to be displayed on a screen of the remote-control device, the GUI displaying a graphical representation of the vehicle and selectable icons representing available directions for vehicle motion, and a location of the remote-control device or operator relative to the vehicle; receiving a second communication signal from the remote-control device requesting that the vehicle move in an operator-selected direction; and causing the vehicle to move in the operator-selected direction.

Another embodiment of the present disclosure is a method of detecting and warning an operator of an off-road vehicle of objects in limited-visibility environments. In an embodiment, the method includes: detecting a limited-visibility environment in a vicinity of the vehicle, the limited-visibility environment caused by airborne particles; detecting a potentially-hazardous object within the vicinity of the vehicle, using a sensor of the vehicle; transmitting data relating to the potentially-hazardous object to a vehicle processor; determining whether the potentially-hazardous object is in a projected path of the vehicle or in a proximity zone of the vehicle; and alerting the operator of the vehicle to the presence and location of the potentially-hazardous object when the potentially-hazardous object is in the projected path of the vehicle or in the proximity zone of the vehicle.

Another embodiment of the present disclosure is a method of alerting an operator of an off-road vehicle. In an embodiment, the method includes: determining whether to issue a warning to an operator of the off-road vehicle; transmitting a control signal to a mechanical vibration-generating device in mechanical connection with a graspable steering device of the off-road vehicle; generating a mechanical vibration output from the mechanical vibration-generating device based on the transmitted control signal; and transferring the mechanical vibration output to the graspable steering device of the off-road vehicle via mechanical contact, thereby alerting the operator of the off-road vehicle.

Another embodiment of the present disclosure is a method of rearward tracking of off-road vehicles. In an embodiment, the method includes: defining a first follow time for a first follow zone, the first follow time being a time duration required to traverse a length of the first follow zone; detecting at a lead off-road vehicle an off-road vehicle following the lead vehicle using a rearwardly-sensing sensor on the lead off-road vehicle; receiving speed sensor data from a speed sensor of the lead off-road vehicle, and determining a speed of the lead off-road vehicle based on the speed sensor data; determining a follow time of the off-road vehicle following the lead off-road vehicle; comparing the follow time of the off-road vehicle to the defined first follow time; and issuing a warning via a human-machine interface (HMI) of the lead off-road vehicle, the warning indicating that the off-road vehicle following the lead vehicle is within the first follow zone.

Another embodiment of the present disclosure is a method for detecting and warning off-road vehicle operators of out-of-sight vehicles. In an embodiment, the method includes: setting parameters of a first virtual vehicle zone associated with a first off-road vehicle; setting parameters of a second virtual vehicle zone associated with a second off-road vehicle; transmitting a communication signal from the second off-road vehicle, the communication signal including data describing the parameters of the second virtual vehicle zone of the second off-road vehicle; receiving at the first off-road vehicle the communication signal from the second off-road vehicle; determining, based on the received communication signal from the second off-road vehicle, including the data describing the parameters of the second virtual vehicle zone, and the parameters of the first virtual vehicles, that the first virtual vehicle zone and the second virtual vehicle zone overlap; and issuing a visual, audible or haptic proximity warning via a human-machine interface device of the first off-road vehicle.

Another embodiment of the present disclosure is a method of changing an orientation of an off-road vehicle in a space-constrained environment. In an embodiment, the method includes: receiving at the vehicle a command to initiate a change of orientation of the off-road vehicle; detecting terrain objects in the space-constrained environment, using a sensor of the off-road vehicle; determining a location of the off-road vehicle relative to the terrain objects; determining a location of a pivot point, the pivot point defining a location on which the off-road vehicle may pivot to accomplish the change in orientation; and displaying a graphical representation of the off-road vehicle, the terrain objects and the pivot point on a display screen of the off-road vehicle.

The above summary of the various representative embodiments of the invention is not intended to describe each illustrated embodiment or every implementation of the invention. Rather, the embodiments are chosen and described so that others skilled in the art can appreciate and understand the principles and practices of the invention. The figures in the detailed description that follow more particularly exemplify these embodiments.

### BRIEF DESCRIPTION OF THE DRAWINGS

The disclosure can be understood in consideration of the following detailed description of various embodiments in connection with the accompanying drawings, in which:

FIG. 1 is a perspective view of an off-road vehicle, according to an embodiment of the present disclosure;

FIG. 2 is a right-side view of the off-road vehicle of FIG. 1, according to an embodiment of the present disclosure;

FIG. 3 is a top view of the off-road vehicle of FIG. 1, according to an embodiment of the present disclosure;

FIG. 4 is a front view of the off-road vehicle of FIG. 1, according to an embodiment of the present disclosure;

FIG. 5 is a rear view of the off-road vehicle of FIG. 1, according to an embodiment of the present disclosure;

FIG. 6 is a right-side view of the off-road vehicle of FIG. 1 with body panels, wheels and other components removed, according to an embodiment of the present disclosure;

FIG. 7 is a block diagram of an advanced driver assistance system (ADAS) of an off-road vehicle, according to an embodiment of the present disclosure;

FIG. 8 is a schematic illustration of an off-road vehicle at a pre-loading position, according to an embodiment of the present disclosure;

FIG. 9 is a schematic illustration of the off-road vehicle of FIG. 8 in a loaded position, according to an embodiment of the present disclosure;

FIG. 10 is a block diagram of an autonomous load-unload assist system, according to an embodiment of the present disclosure;

FIG. 11 is a flowchart of an autonomous loading method for an off-road vehicle, according to an embodiment of the present disclosure;

FIG. 12 is a flowchart of an autonomous unloading method for an off-road vehicle, according to an embodiment of the present disclosure;

FIG. 13 is a flowchart of a semi-autonomous unloading method for loading or parking an off-road vehicle, according to an embodiment of the present disclosure;

FIG. 14 is an illustration of an off-road vehicle responding to an operator gesture, according to an embodiment of the present disclosure;

FIG. 15 is a flowchart of a method for controlling operation of an off-road vehicle using operator gestures, according to an embodiment of the present disclosure;

FIG. 16 is a graphical illustration for display on a human-machine interface, depicting a vehicle icon and selectable vehicle direction icons, according to an embodiment of the present disclosure;

FIG. 17 is a graphical illustration for display on a human-machine interface, depicting a vehicle icon in a position oriented to an operator, and selectable vehicle direction icons, according to an embodiment of the present disclosure;

FIG. 18 is a graphical illustration for display on a human-machine interface, depicting a vehicle icon and vehicle direction icons selectable by swiping, according to an embodiment of the present disclosure;

FIG. 19 is a graphical illustration for display on a human-machine interface, depicting a selectable vehicle icon and vehicle direction icons, according to an embodiment of the present disclosure;

FIG. 20 is a flowchart of a method for controlling operation of an off-road vehicle using a remote control device, according to an embodiment of the present disclosure;

FIG. 21 is an illustration of an off-road vehicle encountering an obscured field of view, according to an embodiment of the present disclosure;

FIG. 22 is a block diagram of a system for detecting, tracking and warning of potentially-hazardous objects while in an opaque or limited-visibility environment, according to an embodiment of the present disclosure;

FIG. 23 is a flow chart of a method of detecting, tracking and warning of potentially-hazardous objects 504 while in an opaque or limited-visibility environment, according to an embodiment of the present disclosure;

FIG. 24 is a schematic illustration of a visual and haptic steering device for an off-road vehicle, according to an embodiment of the present disclosure;

FIG. 25 is a block diagram of a system for alerting an operator of a vehicle using a haptic steering device, according to an embodiment of the present disclosure;

FIG. 26 is an illustration of three snowmobiles traveling in close proximity, the lead snowmobile including a rearward-vehicle tracking and safety-zone system, according to an embodiment of the present disclosure;

FIG. 27 is a block diagram of a rearward-vehicle tracking and safety-zone system, according to an embodiment of the present disclosure;

FIG. 28 is an illustration of speed and time-based follow zones, according to an embodiment of the present disclosure;

FIG. 29 is a flow chart of a method of rearward tracking and vehicle safety-zone establishing, according to an embodiment of the present disclosure;

FIG. 30 is a block diagram of a trail-alert system, according to an embodiment of the present disclosure;

FIG. 31 is an illustration of a pair of off-road vehicles at a blind curve and with overlapping virtual vehicle zones, according to an embodiment of the present disclosure;

FIG. 32 is a flow chart of a method of detecting and warning ORV operators of oncoming, out-of-sight vehicles, according to an embodiment of the present disclosure;

FIG. 33 is a block diagram of an off-road vehicle reorientation system, according to an embodiment of the present disclosure;

FIG. 34 is a graphical depiction of an off-road vehicle on a trail with multiple depicted pivot points, according to an embodiment of the present disclosure;

FIG. 35 is a depiction of a trail view with a graphical depiction of vehicle steering angles as displayed by a heads-up display device, according to an embodiment of the present disclosure; and

FIG. 36 is a flow chart of a method for changing an orientation of a vehicle in a constrained space.

### DETAILED DESCRIPTION

For the purposes of understanding the disclosure, reference will now be made to the embodiments illustrated in the drawings, which are described below. While the invention is amenable to various modifications and alternative forms, specifics thereof have been shown by way of example in the drawings and will be described in detail. It should be understood, however, that the intention is not to limit the invention to the particular embodiments described. On the contrary, the intention is to cover all combinations, modifications, equivalents, and alternatives falling within the spirit and scope of the invention as defined by the appended claims.

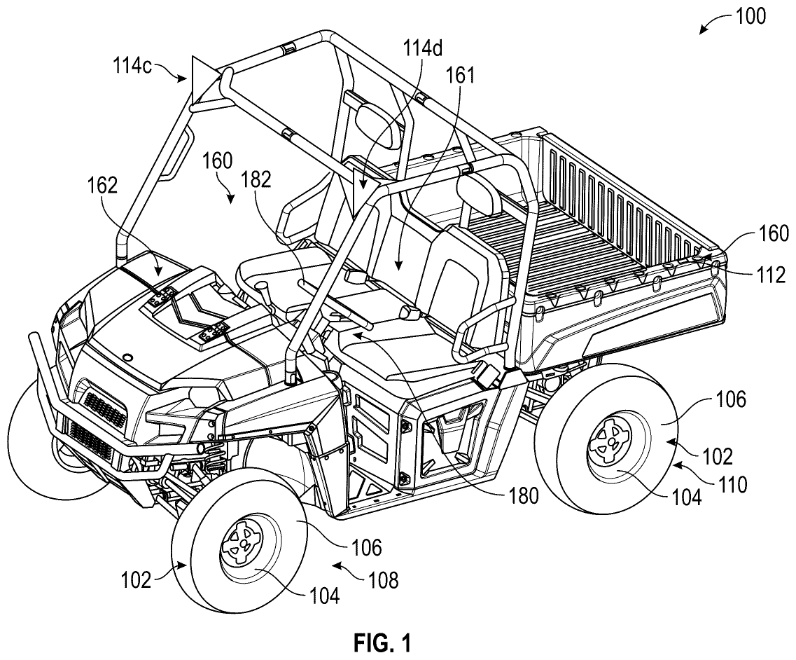

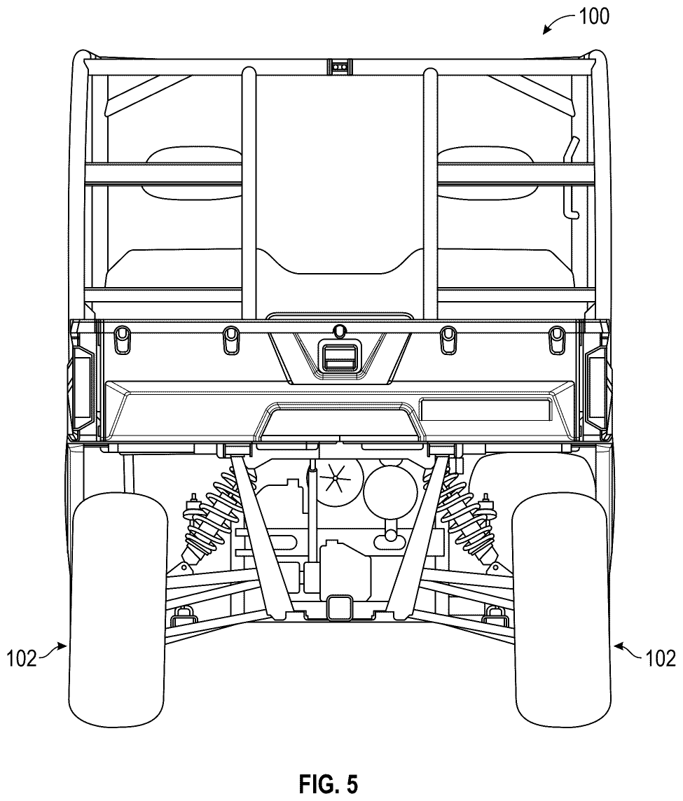

With reference to FIGS. 1-6, an illustrative embodiment of a vehicle 100 is shown. Although vehicle 100 is depicted as a side-by-side off-road vehicle (ORV), it will be understood that vehicle 100 may comprise any of a variety of recreational off-road vehicles whose primary purpose is to travel on terrain other than paved roadways, and includes vehicles such as all-terrain vehicles (ATVs), side-by-side or utility terrain vehicles (UTVs), off-highway motorcycles (OHMs), snowmobiles, and similar such vehicles.

Vehicle 100 as illustrated includes a plurality of ground engaging members 102. Illustratively, ground engaging members 102 are wheels 104 and associated tires 106. Other example ground engaging members include skis and tracks. In one embodiment, one or more of the wheels may be replaced with tracks.

As described herein, one or more of ground engaging members 102 are operatively coupled to a power source 130 to power the movement of vehicle 100. Example power sources include combustion engines and electric engines.

Referring to the illustrated embodiment in FIG. 1, a first set of wheels, one on each side of vehicle 100, generally correspond to a front axle 108. A second set of wheels, one on each side of vehicle 100, generally correspond to a rear axle 110. Although each of front axle 108 and rear axle 110 are shown having a single ground engaging members 102 on each side, multiple ground engaging members 102 may be included on each side of the respective front axle 108 and rear axle 110.

As configured in FIG. 1, vehicle 100 is a four-wheel, two-axle vehicle. In one embodiment, one or more modular subsections (not pictured) may be added to vehicle 100 to transform vehicle 100 into a three axle vehicle, a four axle vehicle, and so on.

Vehicle 100 includes an operator area 160 generally supported by operator area portion 126 of frame 116. Operator area 160 includes seating 161 for one or more passengers. Operator area 160 further includes a plurality of operator controls 180 by which an operator may provide input into the control of vehicle 100. Controls 180 include a steering wheel 182, which is rotated by the operator to change the orientation of one or more of ground engaging members 102, such as the wheels associated with front axle 108, to steer vehicle 100. In one embodiment, steering wheel 182 changes the orientation of the wheels of front axle 108 and rear axle 110 to provide four wheel steering. In examples, controls 180 also include a first foot pedal actuatable by the vehicle operator to control the acceleration and speed of vehicle 100 through the control of power source 130 and a second foot pedal actuatable by the operator to decelerate vehicle 100 through a braking system.

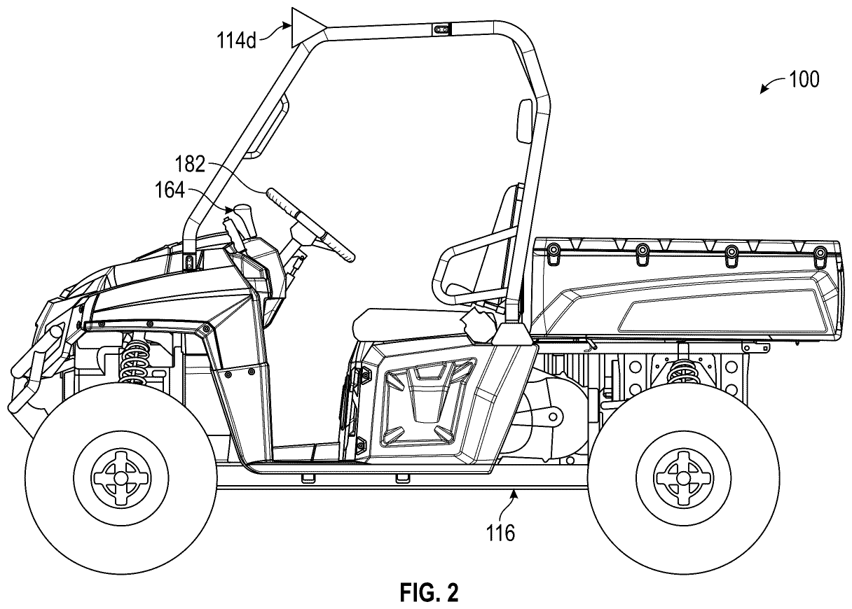

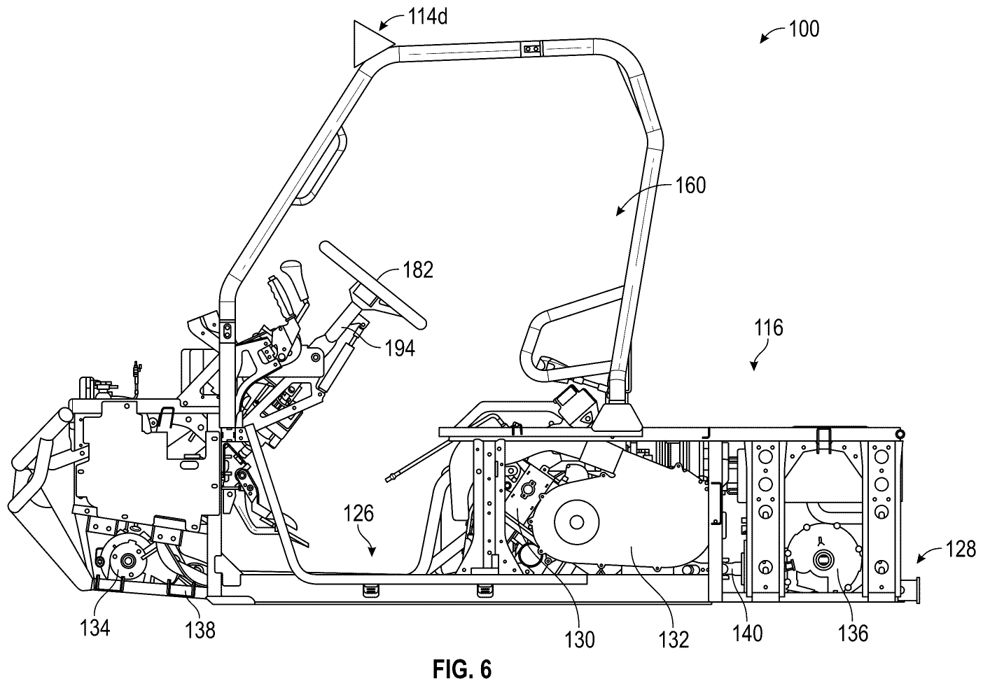

As depicted in FIGS. 2-4, controls 180 may also include gear shift input control 164, which is operatively coupled to the shiftable transmission of transmission 132 (FIG. 6) to communicate whether the shiftable transmission is in a low forward gear, a high forward gear, a reverse gear, neutral, and if included a park position. Although, gear shift input control 164 is shown as a lever, other types of inputs may be used. Gear shift input control 164 is positioned on a right hand side of steering column 194.

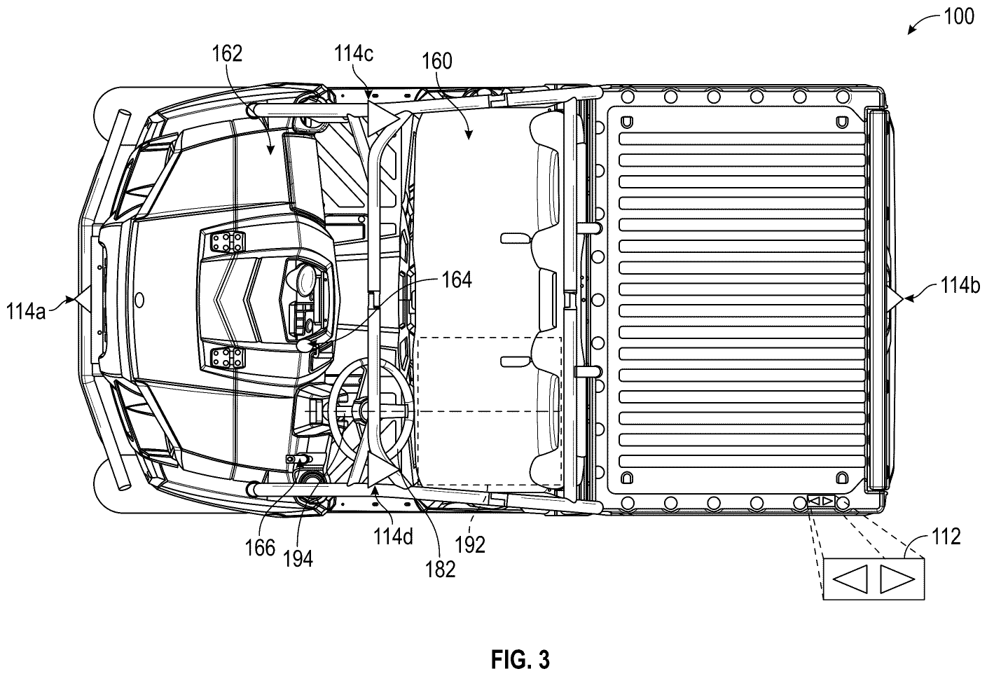

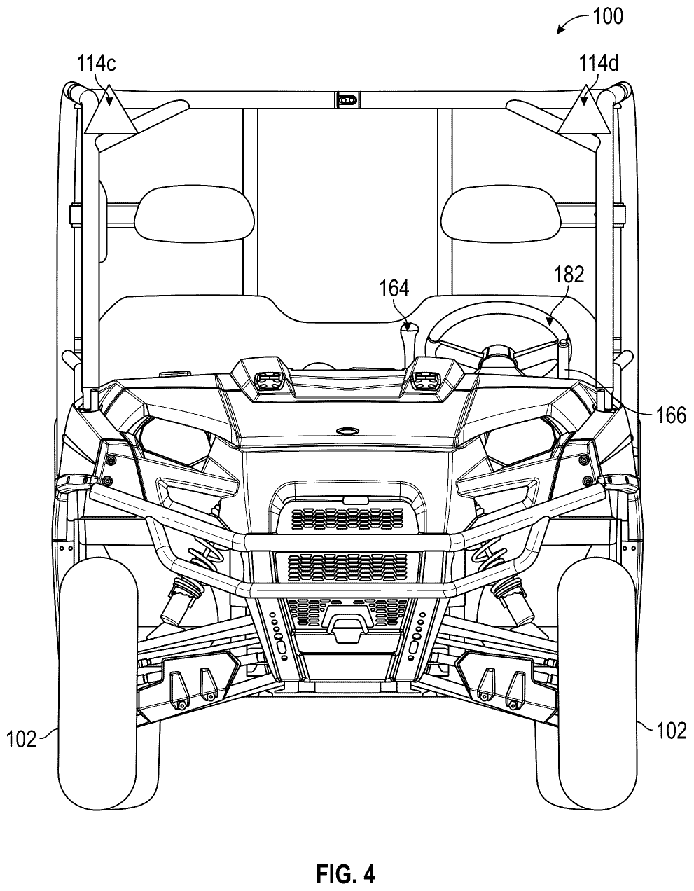

Controls 180 may also include a parking brake input control 166, as shown in FIGS. 3-4. Parking brake input control 166 is operatively coupled to a parking brake of vehicle 100. In one embodiment, the parking brake is positioned on one of drive line 138 and drive line 140. In one embodiment, a master cylinder that is operatively coupled to parking brake input control 166 is positioned underneath a dashboard body member 162. Although, parking brake input control 166 is shown as a lever, other types of inputs may be used. Parking brake input control 166 is positioned on a left hand side of steering column 194.

A vehicle operator position 192 on seating 161 is represented in FIG. 3. A steering column 194 is connected to steering wheel 182 (FIGS. 3 and 6).

Vehicle 100 is further illustrated as comprising object sensors 114, including front and rear sensors 114a and 114b (see FIG. 3) and left and right sensors 114c and 114d. Example sensors include, but are not limited to cameras (e.g., visible light cameras or infrared cameras), LIDAR, radar or ultrasonic sensors, global positioning system (GPS) sensors, magnetometers (e.g., to measure a relative and/or global magnetic field), and/or radio devices. For example, object sensors 114 may each comprise an ultra-wideband (UWB) radio, such that the position of another device (e.g., an operator device or a removable input device) may be determined. As another example, object sensors 114 may include one or more infrared and/or visible light cameras, such that computer vision techniques may be used to perform object recognition to identify one or more objects surrounding vehicle 100 or, as a further example, a heat signature may be used to identify an operator of vehicle 100.

For example, an object may be learned and/or recognized by object sensors 114 using computer vision and/or machine learning techniques (e.g., to identify an object and/or to classify an identified object), such that the object may be tracked, followed, avoided, and/or used for other processing according to aspects described herein. A distance and/or direction of the object may be determined in relation to vehicle 100, for example based on the size and location of a group of one or more pixels associated with the object in image data that is obtained from object sensors 114. In instances where object sensors 114 includes multiple cameras, object detection, depth/distance detection, and/or location detection may be improved using image data that is obtained from different perspectives. For example, a set of anchor points may be identified for each respective perspective, which may be used to generate a two-dimensional (2D) or three-dimensional (3D) representation of an object and/or at least a part of the environment surrounding vehicle 100. It will be appreciated that any of a variety of additional or alternative techniques may be used in other examples, including, but not limited to, photogrammetry and simultaneous localization and mapping (SLAM).

In some instances, object sensors 114 may comprise an emitter and a detector. For example, one object sensor 114 may be an infrared light source, while another object sensor 114 may be an infrared detector, such as a camera capable of detecting infrared light. Accordingly, a target object having a high degree of infrared reflectivity or having a specific pattern may be detected by object sensors 114, thereby enabling vehicle 100 to detect objects. For example, the target object may be attached to an operator or to another vehicle. As another example, the target object may be part of or otherwise integrated into a clothing garment, such as a vest. The target object may have one or more known dimensions, such that a distance between vehicle 100 and the target object may be determined based on the size of the object as captured by object sensors 114, while the bearing may be determined based on the displacement of the object as compared to a center position of object sensors 114. As another example, the bearing may be determined using a plurality of cameras, such that a displacement of the object may be determined for each camera and processed accordingly to generate a bearing of the target in relation to vehicle 100.

While two object sensors 114 are illustrated, it will be appreciated that any number of sensors may be used. Further, each of object sensors 114 need not be the same type of sensor. For example, a camera may be used in combination with a GPS sensor to provide higher resolution positioning than may be obtained with either sensor type individually. It will also be appreciated that object sensors 114 may be positioned at any of a variety of other locations and need not be limited to positions depicted.

As illustrated in FIG. 2, sensors 114 may be positioned on a roof of vehicle 100 or a top portion of a roll cage 117. In an embodiment, sensors 114 may be placed at a front portion of the vehicle to detect objects forward of vehicle 100. One or more sensors 114 may also be placed at a rear of vehicle 100 to detect objects rearward of vehicle 100. Front and rear positioned sensors 114 may also be positioned and configured to detect objects on the left or right sides of vehicle 100, in addition to detecting forward- and rearward-located objects. In some embodiments, additional sensors 114 may be located on one or more sides of vehicle 100, in addition to front- and rear-positioned sensors. Sensors 114 may be connected to a variety of vehicle 100 components, including frame 116, body panels, and so on.

Accordingly, and as explained further below, object sensors 114 may be used to provide object-detection and object-avoidance, including detecting and avoiding other vehicles 100. For instance, object sensors 114 may be used to identify and/or track an object or vehicle 100. Data output from object sensors 114 may be processed to identify objects and/or distinguish between a human operator, a target object, and/or extraneous objects such as grass, trees, or fencing, among other examples.

Referring to FIG. 6, a power source 130, illustratively a combustion engine, is supported by frame 116. Power source 130 is shown as a combustion engine. In one embodiment, power source 130 is a multifuel engine capable of utilizing various fuels. An example multifuel engine capable of utilizing various fuels is disclosed in U.S. Pat. No. 7,431,024, issued Oct. 7, 2008 and entitled “Method and Operation of an Engine”, the disclosure of which is expressly incorporated by reference herein. In one embodiment, power source 130 is a hybrid electric engine. In one embodiment, power source 130 is an electric motor.

Power source 130 is coupled to a front differential 134 and a rear differential 136 through a transmission 132 and respective drive line 138 and drive line 140. Drive line 138 and drive line 140, like other drive lines mentioned herein, may include multiple components and are not limited to straight shafts. For example, front differential 134 may include two output shafts (not pictured), each coupling a respective ground engaging members 102 of front axle 108 to front differential 134. In a similar fashion, rear differential 136 includes two output shafts, each coupling a respective ground engaging members 102 of rear axle 110 to rear differential 136.

In one embodiment, transmission 132 may include a shiftable transmission and a continuously variable transmission (“CVT”). The CVT is coupled to power source 130 and the shiftable transmission. The shiftable transmission is coupled to drive line 138, which is coupled to front differential 134 and to drive line 140 which is coupled to rear differential 136. In one embodiment, the shiftable transmission is shiftable between a high gear for normal forward driving, a low gear for towing, and a reverse gear for driving in reverse. In one embodiment, the shiftable transmission further includes a park setting, which locks the output drive of the shiftable transmission from rotating. In other examples, one or more axles (e.g., axle 108 or 110) may be non-powered axles.

Various configurations of front differential 134 and rear differential 136 are contemplated. Regarding front differential 134, in one embodiment front differential 134 has a first configuration wherein power is provided to both of the ground engaging members 102 of front axle 108 and a second configuration wherein power is provided to one of ground engaging members 102 of front axle 108.

Regarding rear differential 136, in one embodiment rear differential 136 is a locked differential wherein power is provided to both of the ground engaging members 102 of rear axle 110 through the output shafts. When rear differential 136 is in a locked configuration power is provided to both wheels of rear axle 110. When rear differential 136 is in an unlocked configuration, power is provided to one of the wheels of rear axle 110.

Additional discussion of an embodiment of a wheeled vehicle 100 and related aspects are disclosed in U.S. Pat. No. 7,950,486, the disclosure of which is expressly incorporated by reference herein. Embodiments of vehicle 100 that include snowmobiles are described in U.S. Pat. No. 8,590,654, issued Nov. 26, 2013 and entitled “Snowmobile,” in U.S. Pat. No. 8,733,773, issued May 27, 2014 and entitled “Snowmobile Having Improved Clearance for Deep Snow,” in U.S. Patent Pub. No. 2014/0332293A1, published Jul. 23, 2014 and entitled “Snowmobile,” and in U.S. Pat. No. 11,110,994, issued Sep. 7, 2021 and entitled “Snowmobile,” all of which are assigned to Polaris Industries Inc., and all of which are incorporated herein by reference in their entireties.

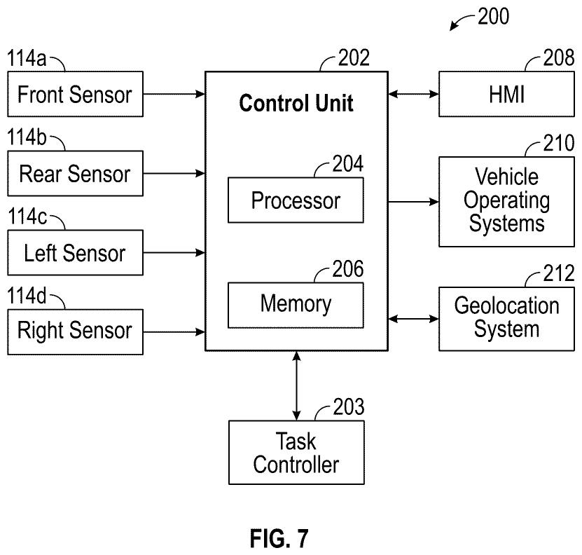

Referring to FIG. 7, in an embodiment, vehicle 100 may also include an advanced driver assistance system 200. The use of advanced driver assistance systems (ADAS) in automobiles is well established and increasingly commonplace. ADAS systems in automobiles may include automatic or emergency brake assist systems, adaptive cruise control, forward and rearward collision warnings, lane keeping or changing assistance systems, and many more. These systems may not only warn drivers of vehicles of their surroundings and impending danger, but may also autonomously respond to potential collisions by braking, steering or decelerating the vehicle. However, the use of ADAS in use in off-road vehicles is not commonplace, and further, the features of ADAS for automobiles are not applicable to vehicles driven off road. Consequently, embodiments of the present description provide autonomous or semi-autonomous assistance to operators of vehicle 100 via an ADAS suited for vehicles intended to be operated primarily off the road.

As depicted in FIG. 7, in an embodiment, system 200 of vehicle 100, which may be an ADAS, includes controller 202 with processor 204 and memory 206, sensors 114, including front, rear, left and right sensors 114a, 114b, 114c, and 114d, respectively, human machine interface (HMI) 208, vehicle operating systems 210 and geolocation system 212. In an embodiment, system 200 may also include an additional processor or controller, such as vehicle task controller 203 dedicated to performing particular vehicle tasks or functions described further below. Task controller 203 may be in direct communication with sensors 114, or may be in communication with sensors 114 via control unit 202. In an embodiment, components of ADAS 130 may be communicatively coupled by a control area network bus (CANBUS).

In an embodiment, controller or control unit 202 includes at least one processor 204 and memory device 206 storing various computer software control modules implementing methods and systems of the disclosure. Processor 204 may comprise a microprocessor, microcomputer, microcontroller, ASIC, or similar, and may be configured to process signals or data, including executing instructions, such as instructions, computer programs, code, etc., stored in memory 206. Control unit 202 may comprise or be integrated into one or more electronic control modules (ECMs) or electronic control units (ECUs) of vehicle 100.

Memory device 206 may comprise any one or more of various known memory devices, such as a RAM, ROM, EPROM, flash memory and so on.

Human machine interface (HMI) 208 may include one or more of various interface devices configured to receive inputs from an operator of vehicle 100 and communicate information to the operator of vehicle 100. HMI 208 may include a display screen, such as a touch screen, a voice-recognition system, buttons, switches, and so on. HMI 208 may be fully or partially integrated into vehicle 100, or in embodiments, may include a mobile device with a user/operator interface in communication with vehicle 100 and system 220. Software programs may be stored in any combination of vehicle 100, HMI 208, or even remote devices. In an embodiment, HMI 208 may include a software application implemented on HMI 208 that provides a user interface, including a graphical user interface for receiving input from the operator to be conveyed to vehicle 100 and its system 220, and communicating information from vehicle 100 to the operator. In an embodiment, HMI 208 may also include an operator warning system configured to communicate warnings to an operator of vehicle 100. Such a warning system may comprise any of known warning devices or systems intended to alert an operator audibly, visually or haptically, such as warning lights, speakers, display devices and so on.

ADAS 200 includes, or is in communication with, vehicle operating systems 210. Operating systems 210 comprises devices and systems configured to control one or more operations of motorcycle 106, such as braking, acceleration/deceleration, steering, suspension, powertrain, electrical, and so on.

In an embodiment, geolocation system 212 comprises a global-positioning system (GPS) device, such as a GPS receiver. In other embodiments, geolocation system 212 comprises other geolocation devices configured to determine a geographical location or position based, such as a device that determines location based on a network connection.

Control unit 202 is in communication with sensors 114, including sensors 114a-114d, HMI 208 and the various vehicle operating systems 210, as depicted. In operation, control unit 202 receives sensor data from sensors 114 and operator input from HMI 208. As will be described in specific applications below, control unit 202 processes this received information from sensors 114 and HIM 208 based on stored computer program instructions and communicates information to the operator via HMI 208 and at the same time, controls or otherwise influences one of more vehicle operating systems 210.

In an embodiment, sensors 114 may be part of a sensing system that detects relative vehicle 100 position, surrounding objects, such as other vehicles and obstacles to be avoided. Control unit 202 may be part of the sensing system, though other controllers or processors implementing saved sensing algorithms may also be used.

Embodiments of vehicle 100 with ADAS 200 and variations thereof are described herein and are configured to perform a variety of autonomous and semi-autonomous vehicle operations, including operator assist and alert operations.

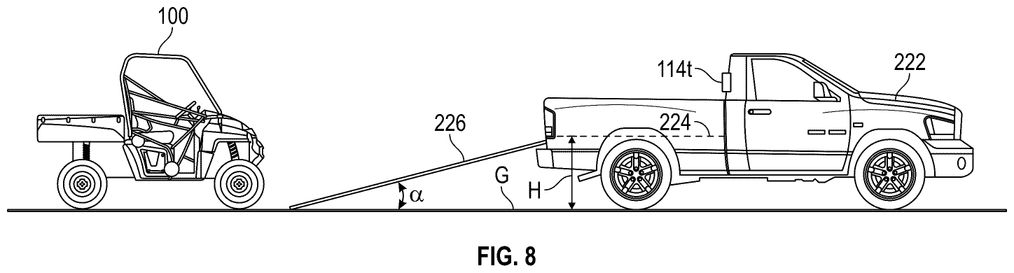

Referring to FIGS. 8-12, an embodiment of autonomous ramp load-unload assist system 220, which may be incorporated into ADAS 200, allows an operator to implement an autonomous method of loading and unloading vehicle 100. Autonomous ramp load-unload assist system 220 implements a semi-autonomous load-unload process that in embodiments utilizes artificial intelligence, machine-learning and camera-vision techniques to provide a ramp-assist feature for convenient vehicle 100 loading and unloading.

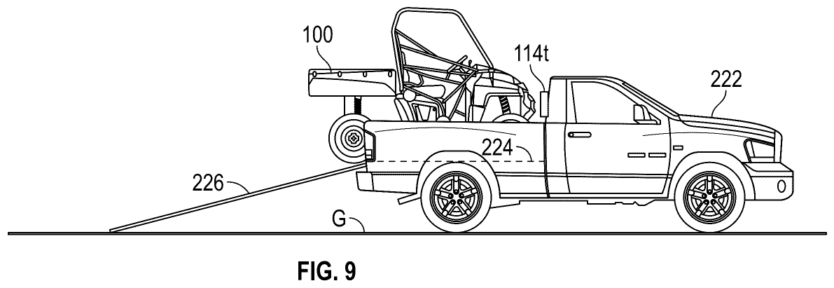

Referring specifically to FIGS. 8 and 9, as off-road vehicles are not allowed to drive on the roads due to emission norms and automotive legislations, users are forced to transport the vehicles to recreational zones with transport vehicles, such as trucks, trailers, and so on. Transporting ORVs to and from desired recreational tracks, means that the vehicles need to be loaded up and down from a trailer or truck bed. This task of manual handling and operating vehicles during loading and unloading can be tedious and dangerous if not done carefully.

FIG. 8 depicts vehicle 100 prior to loading into transport vehicle 222 that includes platform 224 at a height H above ground G. In this pre-loaded position, vehicle 100 is located at or near ramp 226 having a first end placed on the ground G and a second end at or near platform 224. Ramp 226 forms an angle α with generally planar ground G.

FIG. 9 depicts 100 after loading into transport vehicle 222 and onto platform 224. Although such loading could be accomplished by an operator driving vehicle 100 up ramp 226 and onto platform 224, autonomous ramp load-unload assist system 220 facilitates autonomously loading vehicle 100 onto platform 224.

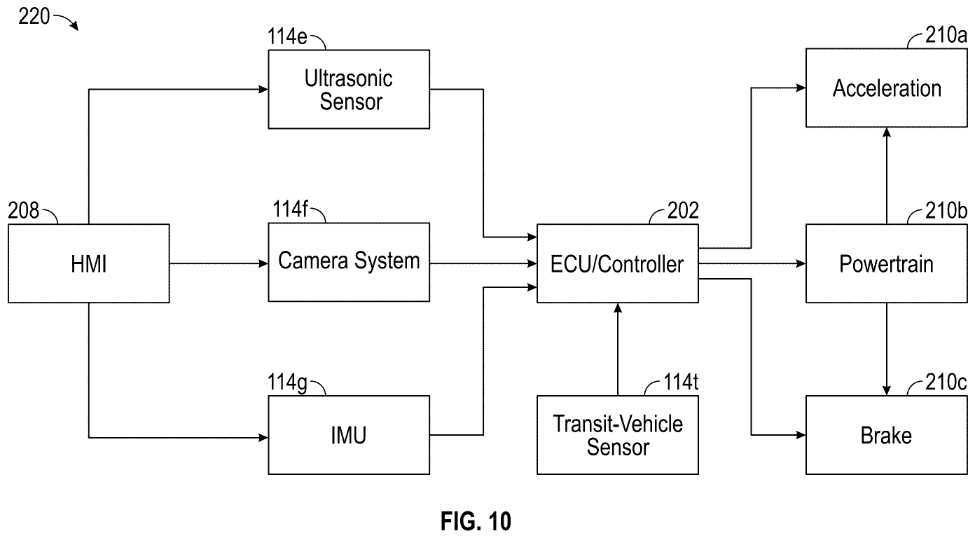

Referring to FIG. 10, an embodiment of autonomous ramp load-unload assist system 220 is depicted. In this embodiment, system 220 includes control unit or controller 202, which may be an ECU or ECM or may be integrated into an ECU or ECM. System 220 also includes human-machine interface (HMI) 208, multiple sensors 114, which in an embodiment includes ultrasonic sensor 114e, camera system 114f, optional transport-vehicle sensor 114t, inertial momentum unit (IMU) 114g, as well as vehicle operating systems 210, which in an embodiment include an acceleration system 210a, powertrain system 210b and brake system 210c.

HMI 208 interfaces with an operator, receiving input from the operator. As described above, HMI 208 may take various forms. In an embodiment, ramp-assist HMI 208 may include a graphical “toggle” or physical switch for implementing operations of autonomous ramp load-unload assist system 220 and its loading and unloading processes. In an embodiment, HMI 208 may include a software application implemented operating on a remote device, such as a smartphone or tablet, that provides a user interface, including a graphical user interface for receiving input from the operator to be conveyed to vehicle 100 and its system 220, and communicating information from vehicle 100 to the operator.

With respect to sensors 114, in an embodiment ultrasonic sensor 114e is mounted to vehicle 100, and is used for obstacle detection. Although sensor 114e is described as an ultrasonic sensor, in other embodiments, sensor 114e may comprise a radar-based, lidar-based or other electromagnetic-based sensor 114e appropriate for detecting obstacles in a vicinity of vehicle 100. IMU 114g may comprise any of a number of known inertial motion devices such as gyroscopes, accelerometers, magnetometers, and so on. Controller 202 may process information from IMU 114g to determine vehicle movement, orientation and location. Controller 202 may also process information from a geolocation device to determine vehicle 100 and/or ramp 226 location.

In an embodiment, transport-vehicle sensor 114t may also be included. Transport-vehicle sensor 114t may be located in transport vehicle 222 and may be detectable by vehicle 100. Although sensor 114t is described as a “sensor,” embodiments of transport-vehicle sensor 114t may simply comprise an item or device detectable by other sensors 114, such as a magnet, magnetic strip or tape, a visually detectable object, such as a printed QR code, and so on. Embodiments of the present disclosure may include processes for locating and/or attaching sensor 114t in an appropriate position for detection. Such processes may include determining a location and affixing the sensor 114t to the determined location, and may be undertaken by a system user or another third party, such as a manufacturer of transport vehicle 222.

Camera system 114f may include one or more cameras for capturing images in the vicinity of vehicle 100. In an embodiment, camera system 114f may include a first camera mounted to a front of vehicle 100 and a second camera mounted to a rear of vehicle 100, for capturing images frontward and rearward of vehicle 100, respectively. Cameras of camera system 114f may be 360° degree cameras.

In this embodiment, system 220 is in communication with vehicle operating systems 210, including acceleration system 210a, powertrain system 210b and brake system 210b.

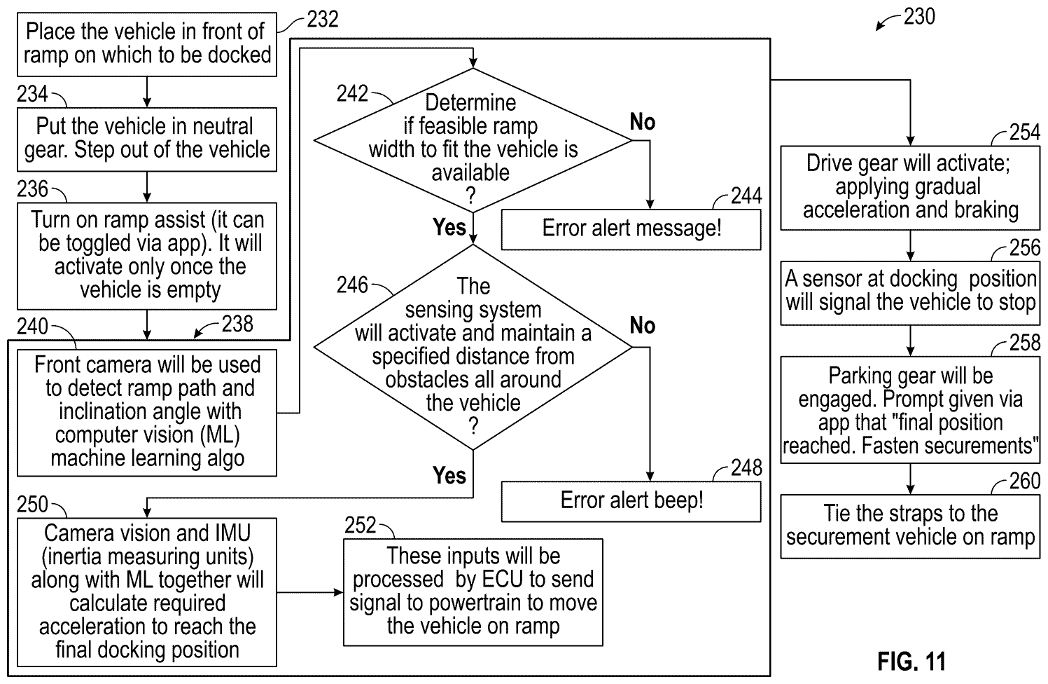

In operation, and as described further below with respect to FIGS. 10 and 11, inputs received from sensors 114, which may include ultrasonic sensor 114e, one or more IMU sensors 114g along with 360-degree cameras of camera system 114f can be processed using a code to enable this autonomous ramp-assist feature. Further, a machine-learning algorithm may be saved in a memory of system 220 which allows system 220 to train itself with a number of scenarios to perform better.

Referring to FIG. 11, a flow chart of an autonomous loading method 230 implemented by autonomous ramp load-unload assist system 220 is depicted.

At step 232, an operator places vehicle 100 in front of ramp 226. Vehicle 100 may be placed or located by the operator of vehicle 100, but in other embodiments, may be maneuvered to an appropriate position autonomously by vehicle 100.

At step 234, the operator puts vehicle 100 in the neutral gear and exits vehicle 100.

At step 236, the operator turns on or implements the ramp-assist function. In an embodiment, the operator interacts with HMI 208 (refer also to FIG. 9), and may actuate a graphical button of a software application or actuate a physical button to start load-evaluation sub-process 238, as described below.

Load-evaluation sub-process 238 evaluates whether conditions are appropriate for loading, and determines operating parameters for moving vehicle 100 up ramp 226 and onto vehicle platform 224. In an embodiment, load-evaluation sub-process 238 includes steps 240 to 252 as follows:

At step 240, a front camera of camera system 114f is used to detect and identify a ramp path and inclination angle α. In an embodiment, the path and inclination angle are determined using a computer-vision machine-learning algorithm. In an embodiment, a global-positioning system (GPS) may be used to determine a position of vehicle 100 relative to ramp 226, and a vehicle path determined in part based on the GPS data. In such an embodiment, GPS could be used not only to identify a position of vehicle 100, but also to identify a position of detectable device or transport-sensor 114t to determine a vehicle path to a desired docked position.114t

At step 242 system 220 determines whether vehicle 100 will fit onto ramp 226. In an embodiment, the fitment evaluation includes comparing a predefined or known width of vehicle 100 with a width of ramp 226, which may be known and stored in a memory, or which may be evaluated by system 220, such as by processing camera images of ramp 226. In an embodiment, system 220 may also detect whether an operator or passenger is located in vehicle 100, which may be via a seat sensor.

If at step 242 system 220 determines that vehicle 100 will not safely fit onto ramp 226, or in some embodiments, that an operator or passenger is in vehicle 100, then at step 244, an error or alert message is issued to the operator. This error or alert message may be in the form of visual or audible messages, including a textual message displayed on a display that may be part of HMI 208, steady or flashing colored lights, a beeping sound, a voice message stating that vehicle 100 is too wide, or similar.

In an embodiment, system 220 may detect an obstacle that might be safely driven over during entry or exit, such as a truck or trailer wheel well. In one such embodiment, system 220 detects the obstacle and determines whether vehicle 100 has sufficient height or clearance to drive over the detected obstacle. In either case, a warning may be issued to the operator, such as a warning that an obstacle exists, and a warning regarding whether vehicle 100 is expected to be able to clear the obstacle during entry or exit.

If at step 244, system 220 determines that vehicle 100 may safely fit onto ramp 226, then at step 246, a sensing system, which in an embodiment comprises sensors 114 and controller 202 or another dedicated processor, such as task controller 203, is activated, and will maintain a predetermined distance from obstacles all around vehicle 100 when vehicle 100 is in motion. If system 220 senses that an object is less than the predetermined distance from vehicle 100, then an error alert is issued at step 248.

At step 250, data from camera system 114f and IMU 114g are processed, which may be by controller 202 or task controller 203 to calculate a required acceleration and/or velocity for acceleration system 210a, for vehicle 100 to reach a final docking position on platform 224.

At step 252, controller 202 processes inputs to generate command signals for operating systems 210, including powertrain system 210b, for the purpose of moving vehicle 100 up ramp 226 and toward platform 224.

At step 254, system 220 communicates with systems 210, causing a drive gear to be activated via powertrain system 210b, causing gradual acceleration of vehicle 100 via acceleration system 210a and braking via brake system 210c, as needed, to move vehicle 100 up ramp 226.

In an embodiment, at step 256, sensor 114t is positioned in transport vehicle 222, and is sensed by system 220. Based on detection of sensor 114 in transport vehicle 222, system 220 determines when to cease acceleration, apply braking, and where to stop vehicle 100. In an embodiment, transport-vehicle sensor 114t is detectable by system 220 so as to determine a distance between vehicle 100 and transport-vehicle sensor 114t. In an alternate embodiment, transport-vehicle sensor 114t is merely a visually detectable device or item having a known size, such that controller 202 processing data from a front camera may determine a distance between vehicle 100 and transport-vehicle item 114t.

In another embodiment, a remote control of loading/unloading is performed by an operator using a handheld remote, which may be a dedicated remote-control device, with or without a screen, or via using a wirelessly connected device like a phone (see email on “Assisted loading/unloading for driver or TeleOp/Remote”). The benefit of this approach vs. automated is that the operator can use their own observations and experience to manage the loading and unloading process, taking into account nuances in that in some scenarios a fully automated process may not fully consider.

At step 258, a parking gear will be engaged. In an embodiment, controller 202 transmits a signal or command to braking system 210c, and a parking brake is automatically actuated. In another embodiment, an operator actuates the parking brake. In the latter embodiment, a message or prompt may be issued to the operator indicating that vehicle 100 has reached its final docking position, and in some embodiments, instructing the operator to secure vehicle 100.

At optional step 260, the operator may secure vehicle 100 to transport-vehicle 222, such as via securement straps.

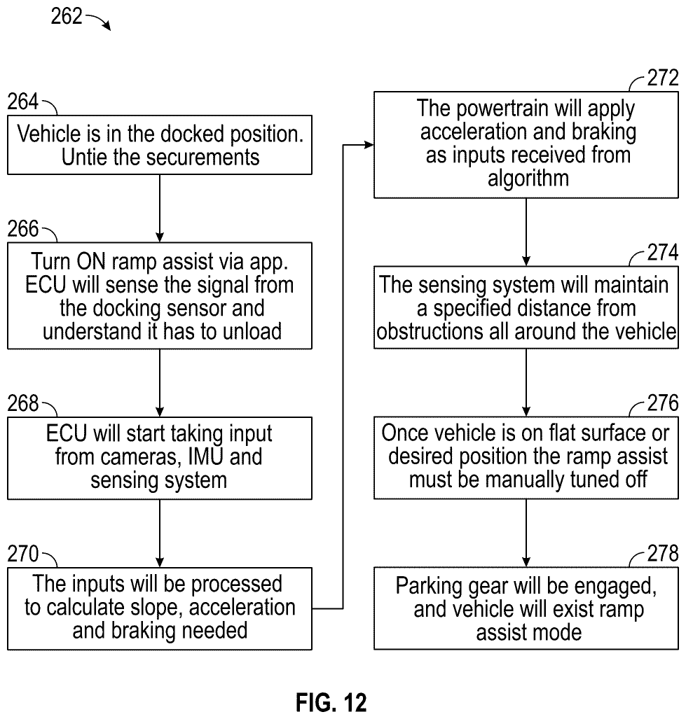

Referring to FIG. 12, a flow chart of an autonomous unloading method 262 implemented by autonomous ramp load-unload assist system 220 is depicted.

At step 264, vehicle 100 is in a stationary position, docked in transport vehicle 222, and the operator unties the securements or straps holding vehicle 100 in transport vehicle 222.

At step 266, the operator engages with HMI 208, which may include a software application installed on a computer, tablet, smartphone or other device to turn on the ramp assist function. In an embodiment, at step 266, system 220 and controller 202 will detect docking or transport-vehicle sensor 114t and determine that vehicle 100 is in the docked or loaded position. In one such embodiment, system 220 detects whether restrains, such as straps or “tie downs” are securing vehicle 100 to transport vehicle 222, and if so, may prevent implementation of the unloading process.

At step 268, ECU or controller 202 receives input from sensors 114, including camera system 114f and IMU 114g.

At step 270 controller 202 processes the inputs received from sensors 114 and calculates a ramp 226 slope or angle α, as well as required vehicle 100 acceleration and braking.

At step 272, powertrain system 210b receives input from controller 202 and causes vehicle 100 to appropriately accelerate in a direction down ramp 226, and directs brake system 210c to brake vehicle 100 as needed.

At step 274, controller 202 receiving input from sensors 114, which in an embodiment comprises a sensing system, will maintain a predetermined distance from objects around vehicle 100 while vehicle 100 is in motion.

At step 276, when vehicle 100 is at a desired or unloaded position, an operator may end the ramp assist function by interacting with HMI 208, which may include changing a toggle position of a graphical or physical toggle or switch.

At step 278 a parking gear may be engaged by system 220 or the operator, and the vehicle will exit the ramp assist mode.

In other embodiments, methods of loading and unloading may combine machine vision plus supervised learning by the operator. In such an embodiment, a vehicle 100 is configured to detect and understand boundaries for loading/unloading via static ID methods (i.e. barcode) but also dynamic identification, which may include camera-based image processing to navigate.

In a first method, while the vehicles camera(s) are on and watching the scene, a touch screen (on vehicle or mobile-like phone or remote device) is used where the operator has a list of possible objects that the system can and should understand in order to navigate in/out/between. Such objects may include immovable walls and floor surmountable objects like wheel wells. A camera feed that the vehicle will see from its perspective may be presented to the user, followed by the user clicking/identifying the bulk mass part of an object or drawing the boundaries of the object and selecting from the list what it is to classify it to the vehicle. This would likely involve the user being asked to create a few typical variations of the observed object (i.e. at daylight, low-light conditions with vehicle headlights on). Afterwards the image feed would show the computer-algorithm identified object boundaries with labels as feedback to the user to confirm its understanding matches the users.

Optical based machine learning is becoming mature tech but it's not foolproof, however supervised learning is the process of providing key information to a machine learning algorithm to improve it in certain use cases and it works well for specific objects. If a user wanted a vehicle to understand optically the navigational boundaries of all trailer internals/sheds/buildings/fences/etc. but only helped classify just the one they owned—current tech would not work perfectly, however if a user only needs to have the vehicle navigate/load/unload a few local objects on their property repeatedly then the classification effort is much easier.

In another method, a remote control with buttons or phone or other dynamically changeable ID is placed on the main nominal center of an exposed boundary object (for each object) while the vehicles camera(s) are on and watching the scene. Next, the user clicks a button with the correct classification on remote/phone/etc. (unless the ID is unique on its own, such as printing different kinds of unique barcodes. For example, in the case of a barn this would be each wall, and perhaps a vehicle hoist-vertical-beam on one side, if one side is a bunch of jumbled stacked smaller objects the user could identify the floor as a way to set the vertical boundary for that side of the barn to load in/out of. In an embodiment, the image processing technology on the vehicle may include camera-based human recognition, and subtract out the user placing the ID such that the full boundary of the object being identified could be learned using historical image feed data.

A benefit to the supervised learning-based process for machine vision navigation is it allows for more nuanced vehicle sensing conditions as time passes.

In another embodiment related to ramp use, a ramp-assist system may assist a user by preventing a vehicle from sliding on ramp 226. In such an embodiment, the ramp-assist system detects oscillations or repeated movement of ramp 226. Such oscillations or repeated movements may be indicative of a poor connection of ramp 226 to transport vehicle 222. Various trailer ramps are physically not connected to the truck or trailer and must be positioned by the operator, which allows for error. When error happens, for example, with a heavy side-by-side vehicle 100, damage to the ramp and/or vehicle 100 may result, including having vehicle 100 tip/roll off of ramp 226 during loading or unloading. The error in ramp mounting can be so slight that ultrasonics or cameras or even LIDAR may not notice it. However, the ramp-assist system via physical vibration monitoring of wheels and driveline and/or audible sensing could pick it up, and alert an operator in the seat so that the operator may pause the load/unload process before a hazard occurs.

Another embodiment includes a reaction method in the vehicle drivetrain to prevent kicking out ramp 226. In some situations, vehicle operators sometimes don't have the right type of ground-to-trailer ramp and kick-out occurs principally during loading but can also happen when unloading. In a vehicle 100 equipped with wheel-speed encoders and/or multi-motor driveline it is possible to sense the onset of kickback by looking for a slight differential in rear or front pairs of wheel speeds vs. the nominal vehicle speed when the breakover angle (where ramp-truck/trailer meet) is being passed at the top which can be known via various sensing methods. Ramps are designed to provide maximum traction for loading/unloading vehicles due to the safety nature of the process, therefore triggering false positives on this function due to wheel poor traction is highly unlikely.

In another embodiment of an assisted loading/unloading method, when an operator is operating vehicle 100 without tele-op controls and line-of sight-feedback, then front or rear of vehicle lights (or other vehicle-mounted lights) flash on either side as the operator drives to indicate a need to correct a steering angle in order to load/unload without hitting objects. Pulsing intensity and/or rate or color or any combination can be used to indicate magnitude of correction needed.

Alternatively if you are holding a remote device with a display screen, the display screen could flash indicators on the screen to correct and/or show ideal steering wheel angle to set. A similar approach could hold if the operator is sitting in the driver's seat where lights are utilized on any number of dash cluster instrumentation or dedicated lights.

Referring again to FIGS. 8-10, in an embodiment, device 114t located in transport vehicle 222, which may be a truck or trailer or other transport vehicle, comprises a detectable device or image, rather than a sensor. In one such embodiment, detectable image 114t comprises a printed detectable code, such as a QR code, detectable by a camera, which may be a front-mounted camera, of camera system 114f. In another embodiment, detectable image 114t may comprise other images, the contents, parameters and so on, being detectable and known to system 220.

In this embodiment, autonomous ramp load-unload assist system 220 may utilize low-cost hardware to improve the operator experience when parking a vehicle in an enclosed trailer or other transport vehicle, such as a truck. In an embodiment, detectable image 114t comprises a printed QR code which is attached, with tape or other means, at a location in or on transport vehicle 222, which in an embodiment may be an end of a trailer or a frontward portion of a truck bed. In other embodiments, detectable image 114t could be placed on a wall in a building, such as a garage or shed for parking vehicle 100. The QR code is viewed by camera system 114f and a processor is used to decipher the code. The processor may be a processor of controller 202, but in other embodiments, may be a separate processor dedicated to detection and deciphering of the QR code of detectable image 114t, such as a task controller 203. A relatively simple or “low-end” dedicated processor, such as task controller 203, may be added to an existing vehicle 100, without changing system architecture significantly, such that such adding such a processor and capability may be relatively low cost.

Upon detecting and deciphering the QR code, a command is communicated to the vehicle control system, such as controller 202. For example, a QR code is used that communicates that vehicle 100 should be parked or stopped a predetermined distance, e.g., 4 feet, from the code, i.e., detectable image 114t, to the vehicle control system. As vehicle 100 is driven into or onto the transport vehicle remotely by the operator, camera system 114f detects the image and based on the number of pixels it takes up or alternatively through ultrasonic sensors 114e, or another sensing method, the vehicle enters a semi-autonomous mode, such as described above, such that vehicle 100 pulls forward until it is the predetermined distance from the QR code of detectable image 114t. Once vehicle 100 is at the predetermined distance away from the QR code, system 220 stops vehicle 100, and a parking sequence is executed manually or automatically.

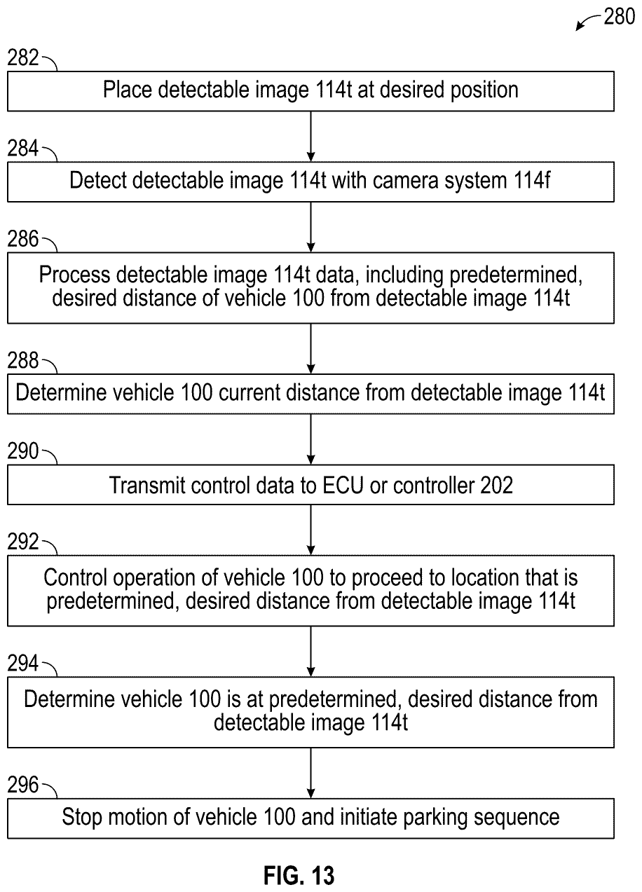

Referring also to FIG. 13, a flow chart of method 280 for semi-autonomously loading or parking vehicle 100 is depicted.

At step 282, an operator or other person places detectable image 114t, which may include a detectable QR code, at a desired position. The desired position may be in or on transport vehicle 222 or at another location, such as on a wall in a building.

At step 284, camera system 114f detects detectable image 114t, which in an embodiment, contains a coded detectable image, such as a barcode, matrix barcode, quick-response (QR) code configured to convey information relating to a desired distance between vehicle 100 and detectable image 114t.

At step 286, a processor processes image information relating to detectable image 114t as received from camera system 114f, including the desired distance between vehicle 100 and detectable image 114t.

At step 288, vehicle 100 determines a current distance from vehicle 100 to detectable image 114t. In an embodiment, task controller 203 receives data from sensors 114 to determine such a distance. In another embodiment, a size and number of pixels of detectable image 114t is known, and the processor determines a distance to the detectable image 114t based on pixel analysis.

At step 290, the processor transmits command data to controller 202, requesting that controller 202 cause operating systems 210 to power vehicle 100 to the desired position at the predetermined distance from detectable image 114t. The control of operating systems 210 is described above with respect to FIGS. 9 and 10, and is accomplished at step 292.

At step 294, system 220 senses that vehicle 100 is a predetermined, desired distance from detectable image 114t, or has arrived at a docking position.

At step 296, vehicle 100 is stopped, and a parking sequence is manually or automatically executed.

Accordingly, and as described above with respect to FIGS. 8-13, autonomous ramp load-unload assist system 220 allows an operator with a click of a button on an app or vehicle to enable hassle-free handling of vehicle 100 to and from the trails. It provides safe and easy loading and unloading of vehicle 100. A sensor system with a combination of ultrasonic sensors 114e, IMUs 114f, and camera system 114g provide the inputs to ECU 202. A machine learning algorithm processes the inputs received from camera vision to identify the loading track or path and calculates the inclination of ramp 226. Further, this information is communicated to acceleration and powertrain system 210a, 210b to actuate and provide a precise amount of acceleration and braking to take vehicle 100 to desired docking position. IMUs 114g provide information about vehicle 100 location and orientation. Ultrasonic sensors 114e make sure the vehicle follows the desired path, and ultrasonic sensors 114e ensure that vehicle 100 avoids obstacles.

As such, autonomous ramp load-unload assist system 220 and corresponding methods provide a number of benefits, including hassle-free and safer loading and unloading of vehicles 100 requiring transport for off-road use, saved time, reduction of accidents or incidents and prevention of vehicle damage.

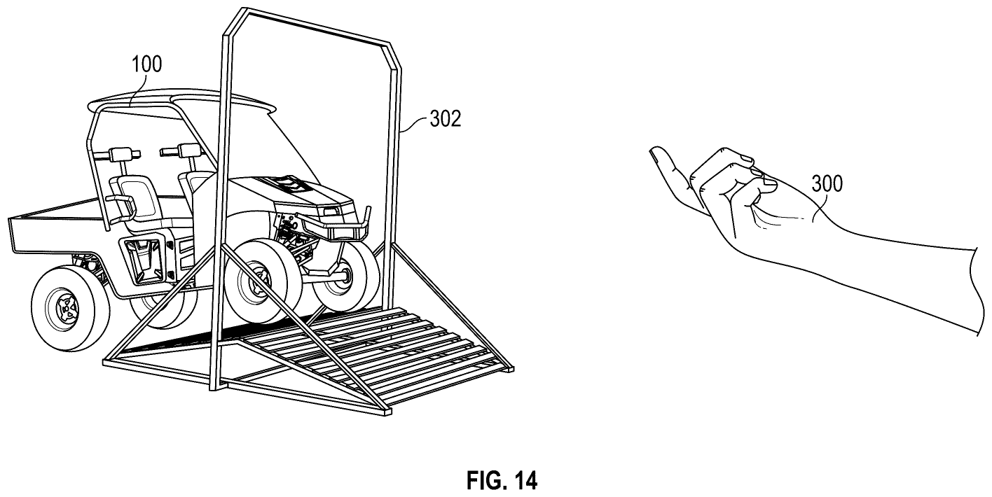

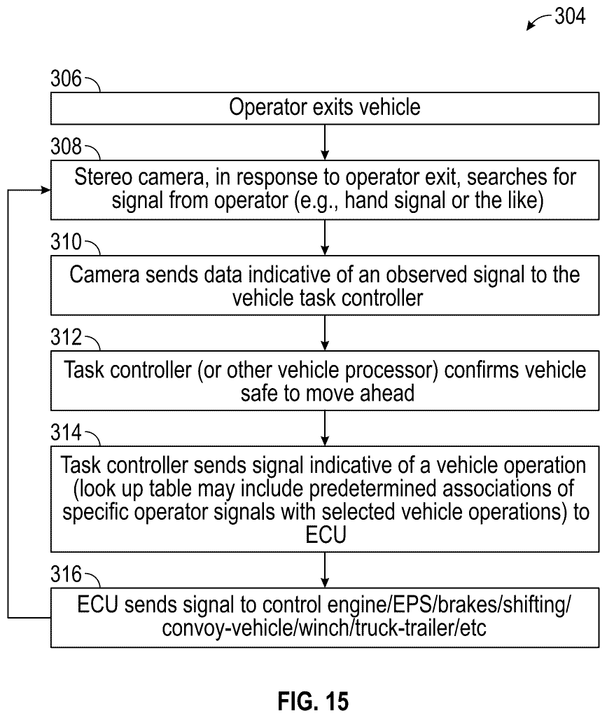

Referring again to FIG. 7, as well as FIGS. 14-15 embodiments of systems and methods for semi-autonomously controlling vehicle 100 using operator gestures are depicted and described. In embodiments, operators can communicate with vehicle 100 from outside the vehicle and without the use of a remote device such as a phone, fob, and so on. This is convenient as such secondary remote devices may not be at the ready when an operator exits vehicle 100. Such functionality also offers convenience and time savings to operators by not requiring the operator to go back to vehicle 100 for low level triggers that don't require it. Embodiments of automatic vehicle control using a remote device such as a fob are described in US Patent Publication No. US 2023/0024039 A1, published Jan. 26, 2023, entitled “Automatic Vehicle Control” and assigned to Polaris Industries Inc., which is incorporated herein by reference in its entirety.

In an exemplary embodiment, and as depicted in FIG. 14, operator 300 may request that vehicle 100 move forward through gate 302 so that the operator does not need to get back in vehicle 100, which can save time. In another use example, operator 300 might require vehicle 100 to very slowly move toward a front of a transport vehicle 222 in the case of the user not being able to see the front of the vehicle, particularly in the case where the transport vehicle 222 is an enclosed trailer where the user cannot see the front of the vehicle. In addition to gesturing to cause motion of vehicle 100, operator gestures may also be used to perform other functions, or actuate systems of features of vehicle 100, such as turning on vehicle 100 lights, starting the engine, honking a horn, and so on.

Vehicle 100 may be substantially the same as described above with respect to FIGS. 1-7, and may include a system the same as or similar to ADAS 200 depicted and described in FIG. 7, including various sensors 114, control unit (controller, ECU or ECM) 202, HIM 208, various operating systems 210 and geolocation device 212. System 200 may also include an additional processor or vehicle task controller in communication with control unit 202 and sensors 114.

In an embodiment, at least one sensor 114 comprises a camera, such as a stereo camera. Sensors 114 may be part of a sensing system in combination with control unit 202 and/or task controller 203 and memory device storing gesture recognition algorithms, gesture look-up tables, and so on.

Referring specifically to FIG. 15, method 304 of semi-autonomously controlling vehicle 100 using operator gestures is depicted and described.

At step 306, operator 300 exits vehicle 100. In an embodiment, step 306 may include vehicle 100 sensing that operator 300 has exited vehicle 100, such as though use of a seat sensor.

At step 308, a sensor 114, which in an embodiment is a camera system, captures repeated images, the images being analyzed by a processor to determine whether an operator 300 gesture is detected. Operator gestures may include any number of gestures, such as visual gestures, including hand gestures. In embodiments, gestures include pointing with hands and/or fingers, waving a hand, pointing with one or more fingers, making a fist, and so on. In some embodiments, gestures may be audible, or audible and visual, such as snapping fingers.

In an embodiment, data defining operator gestures may be stored in a memory device of vehicle 100 and system 200 for reference and comparison to images captured by the camera system. In an embodiment, operator 300 may wear a device, such as a glove equipped with sensors or transmitters that may be detected by a sensor 114 that is a camera or other type of sensor that detects a transmission signal from the wearable device.

At step 310, camera 114 transmits data indicative of an observed operator gesture or signal to task controller 203, and at step 312, task controller 203, or another vehicle processor, confirms that vehicle 100 is ready to move.

At step 314, task controller 203 sends a signal indicative of a vehicle operation to control unit or ECU 202. In an embodiment, certain gestures may correspond to predetermined vehicle operations. For example, making a fist may correspond to a stop command. Pairs of gestures and corresponding operations may be saved in memory in a look-up table as part of system 200.

At step 316, ECU 202 sends appropriate vehicle operation signals to one or more vehicle operation systems 210, e.g., engine control (acceleration, braking, shifting/powertrain), EPS, convoy-vehicle, winch, truck-trailer, etc. causing vehicle 100 to take an appropriate action, such as accelerating, steering and braking.

After step 316, method 304 reverts back to step 308, with camera 114 continuing to capture images and “look” for operator gestures.

While the systems and methods of FIGS. 14 and 15 do not require a remote device, other embodiments of the disclosure include remote devices with innovative user-interfaces for semi-autonomously or remotely controlling operations of vehicle 100.

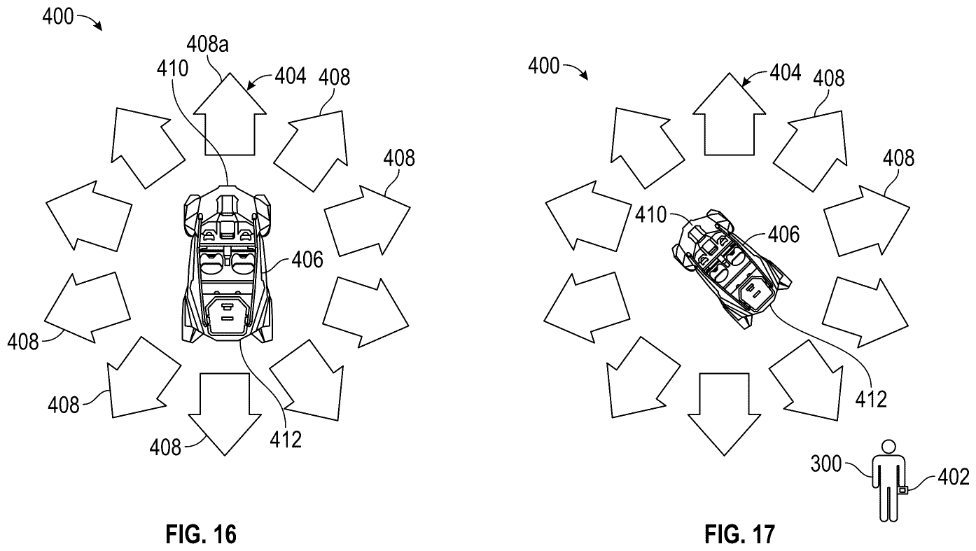

Referring to FIGS. 16-20, embodiments of user-interface 400 and methods of remotely controlling vehicle 100 with a remote device 402 are depicted and described.

As described above with respect to FIG. 7, vehicle 100 generally includes a human-machine interface (HMI) 208, which may include an interactive device physically integrated into vehicle 100, such as an interactive touch-screen device. As also described above, and in embodiments herein, vehicle 100 and HMI 208 may also include, or be associated with, remote devices 402, such as smart phones, tablets, and other hand-held computing devices. Such remote-control devices 402 may include physical controls such as joysticks, buttons, and so on, but may also include graphical user interfaces (GUI). The remote-control devices 402 as an HMI device of FIG. 7 communicates with system 200 and control unit 202 to affect vehicle operating systems 210 to cause vehicle 100 to autonomously move, as also described above with respect to the other embodiments and use cases.

Referring specifically to FIGS. 16 and 17, in an embodiment, user interface 400 is implemented in vehicle remote-control device 402, which may be a smart phone, tablet or other hand-held device. Vehicle remote-control device 402 includes graphical user interface (GUI) 404 which may be displayed on a screen of vehicle remote-control device 402. In an embodiment, a software application stored in and operating on vehicle remote-control device 402 causes GUI 404 to be displayed on a screen of device 402. In an embodiment, vehicle remote-control device 402 may be connected to a network which enables communication with vehicle 100 and/or other remote computer systems and servers.

In an embodiment, GUI 404 includes vehicle icon 406 and a plurality of directional arrows 408 depicted in a top or “birds-eye” view. In an embodiment, vehicle icon 406 is a graphical depiction of vehicle 100, and includes vehicle icon front end 410 and vehicle icon rear end 412, representing a front end and rear end of vehicle 100, respectively. As such, operator 300 may determine an orientation of vehicle 100 relative to the operator, as described further below. Each graphical directional arrow 408 represents a direction option for vehicle 100 that is selectable by operator 300. Each arrow 408 indicates a direction relative to vehicle 100 orientation. For example, arrow 408a indicates a direction that is forward from vehicle 100, or in other words in a rear-to-front direction relative to vehicle 100. In the depicted embodiment, GUI 404 includes 10 directional arrows 408, but in other embodiments, GUI 404 may include more or fewer arrows 408 depending on a desired granularity of vehicle direction options desired.

Referring to FIG. 17, in an embodiment, GUI 404 dynamically adjusts a position of vehicle icon 406 based on a position or location of operator 300. In contrast, in the embodiment of FIG. 16, vehicle icon 406 may always be depicted in a same position on a screen of vehicle remote-control device 402, regardless of a location of operator 300. In the embodiment of FIG. 16, vehicle icon 410 is constantly depicted with vehicle icon front end 410 toward a top of a screen and vehicle icon rear end 412 depicted at a bottom of a screen of vehicle remote-control device 402.

Still referring to FIG. 17, in this bird's eye view, vehicle icon 406 is dynamically rotated relative to vehicle directional arrows 408 as a location of operator 300 changes. In the embodiment depicted, operator 300 is rearward of actual vehicle 100, such that vehicle icon 406 is rotated accordingly. In an embodiment, a graphical depiction or icon of user 300 is not depicted in GUI 404. In other embodiments, a graphical representation of operator 300 is depicted in GUI 404, and is depicted at a position rotationally correct relative to vehicle icon 406. By depicting a top or bird's eye view, and adjusting an orientation of vehicle icon 406, operator 300 may more intuitively choose a motion direction for vehicle 100.

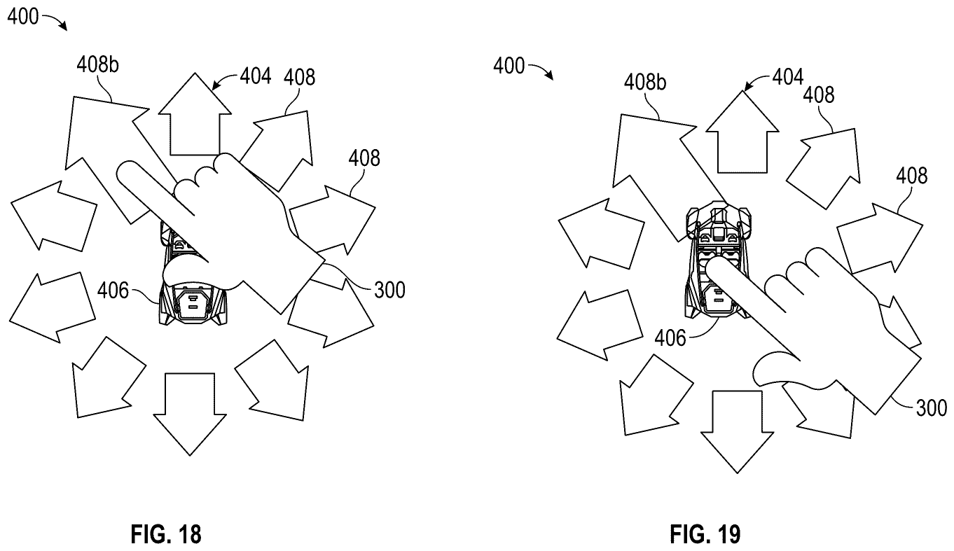

Referring to FIG. 18, in an embodiment, operator 300 may indicate a desired direction of motion for vehicle 100 by touching or pressing on the desired directional arrow. As depicted, operator 300 is selecting directional arrow 408b, thereby requesting that system 200 cause vehicle 100 to move in the selected direction, relative to vehicle 100, i.e., forward and slightly left.

Referring to FIG. 19, in another embodiment, operator 300 may indicate a desired direction of motion for vehicle 100 by touching and “sliding” vehicle icon 406 in a desired direction. In an embodiment, the vehicle directional arrow 408 corresponding to the direction of operator's sliding movement or motion may provide an indication of the selected direction, such as by changing color, increasing in size, or though other visual indications.

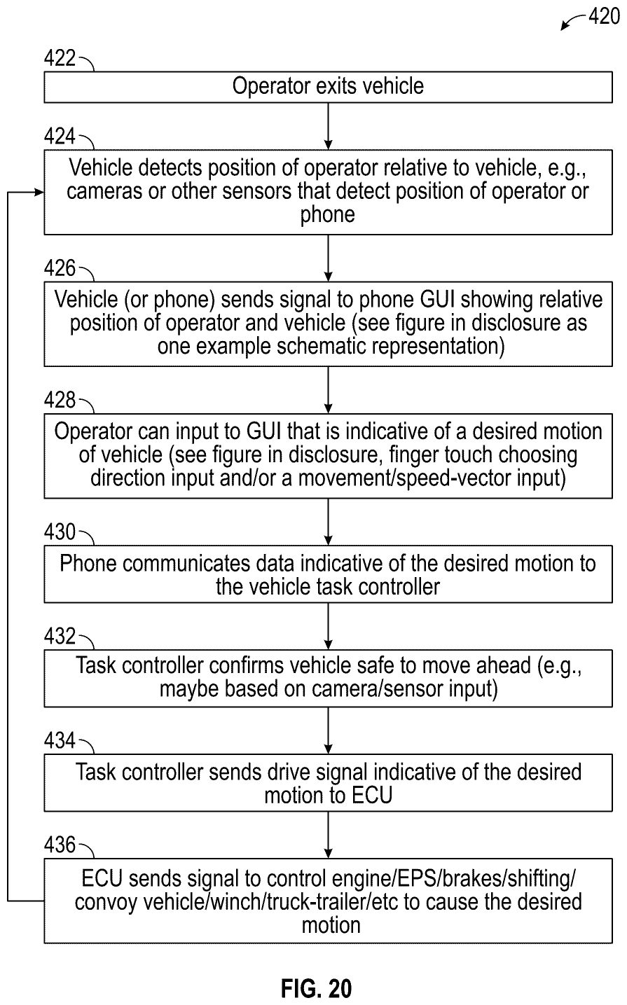

Referring to FIG. 20, a flow chart of an embodiment of method 420 of autonomously controlling vehicle 100 using vehicle remote-control device 402 is depicted.

At step 422, operator 300 exits vehicle 100. In an embodiment, vehicle 100 may include a seat or other sensor to detect when operator 300 is seated in vehicle 100.

Referring also to system 200 as depicted in FIG. 7, in an embodiment, at step 424, vehicle 100 detects a position relative to vehicle 100 using sensors 114, such as cameras or other sensors that are configured to detect a position of operator 300 or a remote-control device 402, which in an embodiment is a smart phone.

Referring still to FIG. 20, and also to FIG. 19, at step 426, vehicle 100 or vehicle remote-control device 402 communicates a signal to user interface 400 causing GUI 404 to be displayed on remote-control device 402. In an embodiment, step 426 may also include displaying a relative position of operator 300 and vehicle 100.

At step 428, operator 300 interacts with GUI 404 to indicate a desired direction of motion. In an embodiment, operator 300 presses or selects directional arrow 408, or swipes vehicle icon 406.

At step 430, vehicle remote-control device 402, which may be a smart phone, communicates data indicative of the desired motion to vehicle task controller 203.

At step 432, task controller 203 confirms that it is safe for vehicle 100 to be set in motion. In an embodiment, sensors 114, which may include cameras, ultrasonic sensors, and other sensors, provide environmental information to ECU 202 or task controller 203 which processes the received environmental information and determines whether to allow vehicle 100 to be set in motion.

At step 434, if safe to do so based on step 432, task controller 203 sends a drive signal indicative of the desired motion to ECU 202.

At step 436, ECU 202 sends appropriate vehicle operation signals to one or more vehicle operation systems 210, e.g., engine control (acceleration, braking, shifting/powertrain), EPS, convoy-vehicle, winch, truck-trailer, etc.

After step 436, method 420 reverts back to step 424 and steps 426 to 436 are repeated as needed.

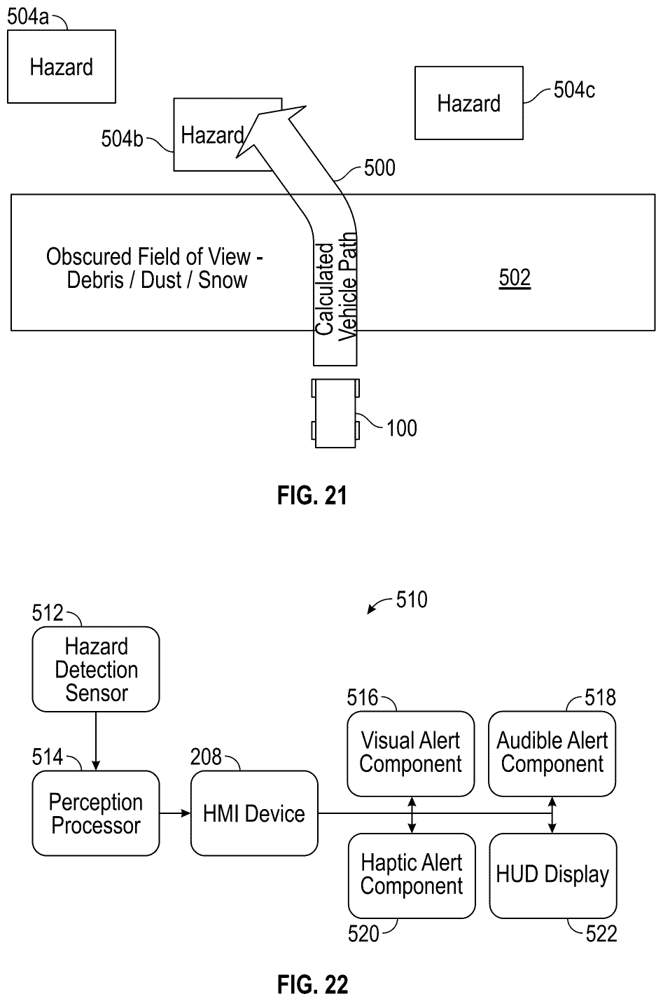

In addition to the above-described semi-autonomous systems and methods that provide control of vehicle 100 primarily while the operator is outside of the vehicle, embodiments of the present disclosure also include systems and methods for assisting the operator while operating vehicle 100. Referring to FIGS. 21-23, systems and methods that assist an operator during operation of vehicle 100 in environments with reduced operator visibility.

Operating a vehicle, such as ORV 100, can be hazardous while riding with a group in an environment that can block the vehicle operator's vision. The operator's line of sight can be diminished by dust, snow, precipitation, etc. As described further below, embodiments of the present disclosure apply a forward-facing sensor on vehicle 100 and communicate with the sub-systems of the vehicle to detect, track and warn the operator of a hazardous object in, or near, the vehicle's existing path of direction. In an embodiment, the sensor's vision performance will not become degraded when exposed to an opaque environment (dust, snow, heavy precipitation). After an object is detected and calculated to be in the vehicle's path (or close enough that it could become a hazard), a warning is transmitted by means of visual, haptic or audible feedback to the driver of the vehicle. This warning communicates the relative position and relative range of the potentially-hazardous object in order to allow the operator to react accordingly and in a timely manner.

Some known technologies which are aimed at automotive passenger cars for on-highway use where vision is usually fairly good. However, during on-highway vehicle use of a vehicle, when visibility decreases on highways, the driver can use consistent landmarks to orient themselves, such as lane lines, fog lines, road edges, and so on. In contrast, embodiments of the present disclosure provide systems and methods that improve operator awareness where a consistent or well-traveled, marked path doesn't exist, such as mountain snowmobiling, on ORV trails, “scramble” areas, etc., and/or where consistent landmarks don't exist.

Referring to FIG. 21, a block diagram of vehicle 100 operating off-highway in a limited-visibility, obscured-vision or opaque environment is depicted. As depicted, vehicle 100 is proceeding along a calculated vehicle path 500 and about to enter limited-visibility region 502. Limited visibility or vision obstruction may be due to dust, snow, rain, or other airborne particles. Potentially-hazardous objects 504, including potentially-hazardous objects 504a, 504b and 504c, are present in a region beyond limited-visibility region 502. In embodiments, potentially-hazardous objects 504 may include stationary obstacles such as rocks, trees, debris, other vehicles, and so on, but may also include moving “objects” such as other vehicles. In such an environment, and without embodiments of the present invention which are configured to detect, track and warn of such potentially-hazardous objects, vehicle 100 would be at significant risk of contacting object 504b. As such, in embodiment, a “potentially-hazardous object” may be an object in a projected path of vehicle 100, and that may cause damage to, or interfere with operation of, vehicle 100.

Referring also to FIG. 22, an embodiment of system 510 for detecting, tracking and warning of potentially-hazardous objects 504 while in opaque conditions is depicted. In an embodiment, system 510 may be part of, or incorporated into an ADAS, such as ADAS 200 depicted and described above.

In an embodiment, system 510 includes potentially-hazardous-object-detection sensor (hereinafter referred to as “hazard-detection” sensor) 512, perception processor 514, and HMI 208.

Hazard-detection sensor 512 may be similar or the same as one of the sensors 114 described above, and may comprise radar-based sensors, lidar-based sensors, infrared sensors, cameras, and so on. In an embodiment, hazard-detection sensor 512 is mounted to a front portion of vehicle 100, to detect hazards 504 located generally forward of vehicle 100. In other embodiments, hazard-detection sensor 512 may include additional side or rear sensors. Hazard-detection sensor 512 is communicatively coupled to perception processor 514.

Perception processor 514 may be a processor associated with, or integrated into a vehicle 100 ECM or ECU, or in other embodiments, may be a separate or dedicated processor or task controller that may include memory and may store computer-program instructions. Perception processor is communicatively coupled to HMI device 208.

HMI 208, as described above with respect to other system embodiments, is a human-machine interface, providing an interface between the operator and vehicle 100. HMI 208 may include any of the devices and/or characteristics of HMI 208 as described above. In an embodiment, and as depicted, HMI device 208 includes one or more of visual alert component 516, audible alert component 518, haptic alert component and display 522, which in an embodiment is a heads-up display (HUD).

In an embodiment, visual alert component 516 may comprise any of a variety of visual alert devices or systems, including, but not limited to lights, such as light-emitting diodes (LEDs), configured to turn on, flash, or change color, screens displaying alert messages, and so on. Visual alert component 516 may comprise a portion of a display of an HMI or other display device of vehicle 100 normally configured to display other information. Visual alert component 516 is configured to visually alert the operator of vehicle 100 to the presence and in some embodiments, location, of potentially-hazardous objects 504.

Audible alert component 518, in an embodiment, may comprise any of a variety of visual alert devices and systems intended to alert the operator of vehicle 100 to the presence of potentially-hazardous objects 504. Embodiments include devices that produce audible sounds intended to warn, such as beeping sounds or in some embodiments, human voice sounds that convey alert messages and related information.

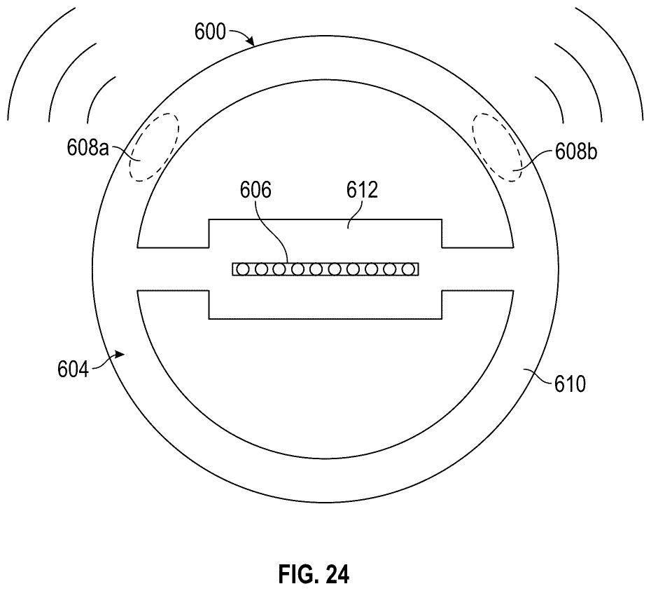

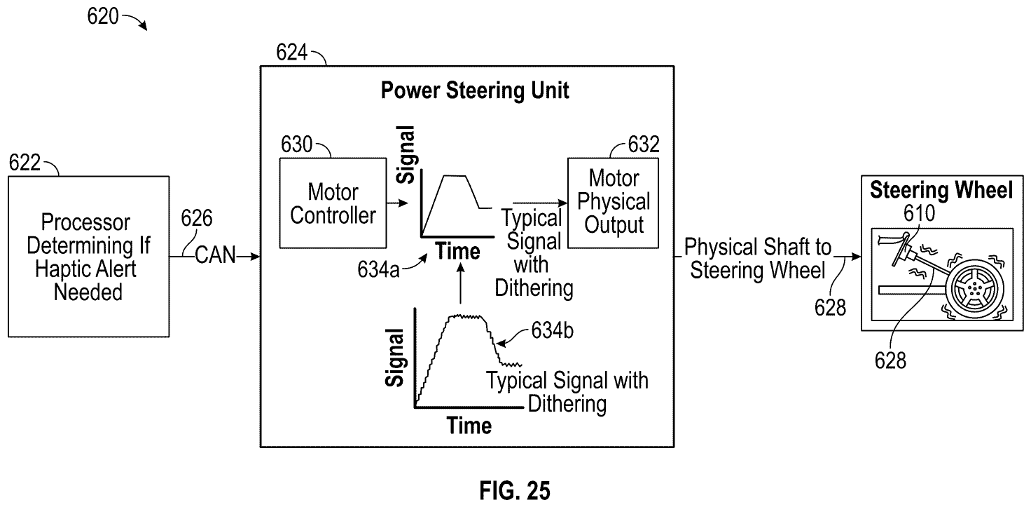

In an embodiment, haptic alert component 520 may comprise any of a variety of haptic alert devices and systems intended to alert the operator of vehicle 100 to the presence of hazards 504. Such haptic devices may be configured to vibrate, move or otherwise be detectable by the operator via sense of touch. In an embodiment haptic alert device 520 may include a vibrating component of vehicle 100, such as a steering wheel, seat or seat belt. In a seat belt embodiment, a seat belt tension may be changed to provide an alert. Another embodiment of a haptic alert device that comprises a tactile or haptic steering wheel for ORVs is described below with respect to FIGS. 24 and 25.

Display 522, which may be a HUD display, also may be configured to alert an operator of vehicle to a nearby or upcoming hazard. In an embodiment, display 522 displays a graphical representation of icon of a potentially-hazardous object 504 to the operator. In one such embodiment, display 522 may also display a relative location of the hazard 504, such as by locating the graphical icon of the hazard at a particular relative location on a display screen of the display device 522. Display 522 may also display a map or grid representing an area in the vicinity of vehicle 100, particularly a forward area, the map including an icon of the potentially-hazardous object 504 to alert and identify a location of the potentially-hazardous object 504.

Display 522 may also include an additional display device, or alternatively include, a display device, configured to display the map or grid depicting the potentially-hazardous object 504.

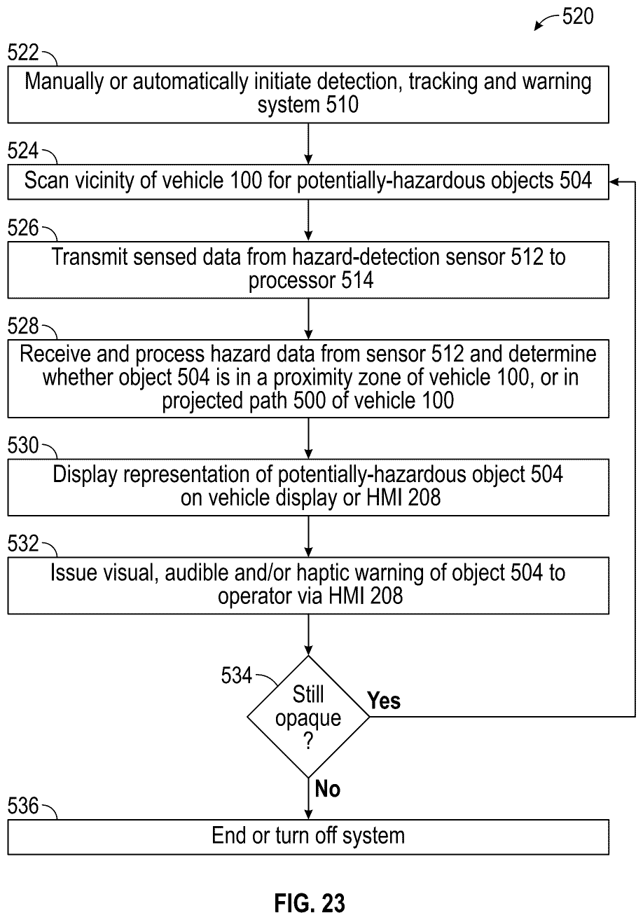

In general operation, and as described further below with respect to the flowchart of FIG. 23, hazard detection sensor 512 detects potentially-hazardous object 504 in a vicinity of vehicle 100, and transmits data signals to perception processor 514. Perception processor 514 is configured to receive the transmitted hazard-data signals and to process such signals, along with other vehicle and sensor data, that may include vehicle projected path 500, vehicle 100 speed, steering angle and so on. Perception processor 514 determines whether a potentially-hazardous object 504 is in the vicinity of vehicle 100, and if so, transmits a signal to HMI 208, causing one or more visual, audible or haptic alerts to be issued to the operator of vehicle 100. In an embodiment, perception processor 514 is also configured to cause HMI 208 to display potentially-hazardous objects 504 on a display screen, such as a display device of HMI 208.

Referring also to FIG. 23, a method 520 of detecting, tracking and warning of potentially-hazardous objects 504 while in opaque conditions is depicted and described.

At step 522, system 510 is initiated manually by the operator of vehicle 200, or is initiated automatically through detection of an opaque or limited-visibility region 502 or obscured field of view. In an embodiment system 510 may be turned on or initiated by an operator actuating a physical button or toggle, or by actuating a graphical button or toggle or menu item of a display screen of vehicle 100.

In another embodiment, system 510 may be initiated automatically. In one such embodiment, hazard-detection sensor 512 may detect the limited-visibility environment, such as via a camera, precipitation detector, or similar, such that system 510 automatically turn on system 510. System 510 may alert the operator that system 510 has been turned on due to opaque or limited visibility conditions.

In other embodiments, system 510 is continuously on and operational, regardless of whether a limited-visibility environment is present or detected.

At step 524, hazard-detection sensor 512 “scans” vicinity of vehicle 100 for potentially-hazardous objects 504. In embodiments, scanning may include sending radar, lidar or other electromagnetic signals outward from vehicle 100, followed by receiving reflected signals back at sensor 512.

At step 526, hazard-detection system 512 transmits or communicates data relating to potentially-hazardous objects 504 to perception processor 514 for processing.

At step 528, perception processor 514 receives and processes data received from hazard-detection system 512. In an embodiment, perception processor 514 also receives and processes data from other vehicle 100 systems and sensors, such as data relating to vehicle location, speed, steering angle, and other onboard sensors. In an embodiment, perception processor 514 processes the received data to determine if vehicle 100 is likely contact potentially-hazardous object 504, such as by calculating vehicle path 500 and comparing to a location of the object.

In an embodiment, perception processor 514 may determine a vehicle proximity zone defined as a predetermined space in or around vehicle 100. If a detected potentially-hazardous object 504 is in the proximity zone, or is determined to be in the proximity zone with further vehicle 100 movement, the object may be defined as a potential hazard 504.

At step 530, if a potentially-hazardous object 504 is identified, then, in an embodiment, potentially-hazardous object 504 is displayed to the operator via a vehicle display or HMI 208.

At step 532, a visual, audible and/or haptic warning regarding potentially-hazardous object 504 is conveyed to the operator via HMI 208. In an embodiment, in addition to a warning, or instead of a warning, system 510 may be configured to autonomously initiate braking of vehicle 100 in response to perception processor 514 detecting a potentially-hazardous object 504 in or near the proximity zone. In such an embodiment, perception processor 514 may cause a communication to vehicle control unit 202 or vehicle operating systems 210 to cause a braking system of vehicle 100 to engage in response to the hazard detection. In a similar embodiment, system 510 may be configured to control an amount of braking power applied to vehicle 100 when a potentially-hazardous object 504 is detected, such as modifying or overriding braking inputs applied by the operator, such as by applying a smoother, more linear braking force when an object 504 is detected, overriding a more abrupt and potentially dangerous braking force applied by the operator, such as in a panic situation. In yet another embodiment, perception processor 514 may be configured to cause a communication to be sent to vehicle control unit 202 or vehicle operating systems 210 to cause vehicle 100 to autonomously steer vehicle 100 away from object 504.

At step 534, if an opaque environment, or limited visibility environment is still detected, then the process repeats for steps 524 to 534. If at step 534, the opaque environment or condition has ceased, at step 536, the process ends, and system 510 may be inactivated. However, in an embodiment, process 520 may also include the step of maintaining activation of system 520 if potentially-hazardous object 504 are still detected, even if the opaque environment is no longer present.

Referring now to FIGS. 24 and 25, an embodiment of visual and haptic steering device 600 and steering-device system 602, for ORVs is depicted. As described above with respect to FIGS. 21-23, system 510 for detecting, tracking and warning of hazards 504 may include a haptic alert component 520, such as a haptic steering wheel. Visual and haptic steering wheel 600 may be one such haptic alert components, and may be used in system 510, or in other similar systems or ADAS 200 for alerting or warning an operator, as described further below.

Currently, ORV operators must look at their gauge or display for vehicle information, fault lamps, and indicators, including warning indicators. Depending on where the gauge or display is located, viewing the gauge or display could require the operators to take their eyes of the trail/road. With visual and haptic steering device 600 on a vehicle 100, the need to need to look at the gauge/display may be reduced. Additionally, operators can receive visual and haptic warning notification in real time. In an embodiment, the visual and/or haptic indication provided by steering device 600 may itself represent a warning of a particular type. In other embodiments, a visual and/or haptic indication provided by steering wheel 600 may be an indication to the operator that the operator should view gauges or displays, such as an in-vehicle infotainment (IVI) device or system, of vehicle 100 to receive information, such as a warning. In such an embodiment, an operator need not regularly look down at the vehicle gauges or displays to see if any warnings, notifications or other information is being presented that the operator might not otherwise be noticed, as described in more detail below.

Referring specifically to FIG. 24, an embodiment of a visual and haptic steering device 600 of vehicle 100, which in an embodiment is a visual and haptic steering wheel, is depicted. In this embodiment, visual and haptic steering device 600 includes graspable steering device 604, visual indicator device 606, and one or more vibration devices 608, including vibration device 608a and 608b.

In an embodiment, graspable steering device 604 comprises a steering wheel, similar to a steering wheel that may be used on known ORVs and boats. In other embodiments, graspable steering device 604 comprises handlebars, such as may be used on snowmobiles, ATVs or motorcycles. Although depicted as a steering wheel, it will be understood that graspable steering device 604 may comprise other graspable shapes. In an embodiment, graspable steering device 604 may comprise graspable portion 610, which is circular or wheel-shaped in the depicted embodiment, and cross member 612. Cross member 612, when present, extends between left and right sides of graspable portion 610.

Visual indicator device 606 may be connected to, or integrated into cross member 612, facing away from an outer surface of cross member 612 to be visible to an operator of vehicle 100. In an embodiment, visual indicator device 606 comprises one or more lights, such as LEDs. In an embodiment, visual indicator device 606 comprises a light bar with multiple LEDs arranged serially. Visual indicator device 606 in an embodiment may be configured to emit light of one or more colors. In an embodiment, each color corresponds to a particular indication. For example, emitting red light may correspond to a warning requiring immediate attention; emitting yellow light may correspond to a notification that does not require immediate attention, but indicates that information is available for the operator to view.

In an embodiment, visual indicator device 606 may include individually-controlled lights controllable not only to emit and/or change color, but also to flash, or be turned on and off in sequence. In such an embodiment, visual indicator device 606 may be configured to indicate many different types of warnings, messages and information. In one embodiment, visual indicator device 606 may be configured and controlled to convey navigation information. For example, a right side of visual indicator device 606 may emit light, including emitting a particular color or turning on and off, and so on, thereby indicating that an operator should prepare to turn right, or a left side of device 606 may emit light to indicate an upcoming left turn. In other embodiments, visual indicator device 606 may indicate information relating to other operators of other vehicles, such as vehicle proximity or tracking information, as well as indicate other operator or other vehicle distress signals. In some embodiments, visual indicator device may indicate a vehicle speed, such as exceeding a speed limiting, or may relay a message from another operator in another vehicle to follow that vehicle.

Other warnings and notifications may inform an operator of: a check engine light turning on (viewable at the gauges or vehicle display); a chassis lamp turning on; a fellow rider or buddy “SOS” signal; TPMS (tire pressure monitoring system) warning light indicating a low tire or rapid loss alert (a left or right tire could be indicated with a corresponding left or right indication by visual indication device 606); low-fuel lamp turning on; low-battery lamp turning on; transmission overheat/warning lamp turns on; trail guidance (left or right turn ahead as indicated by lights or haptics as described below); trail alert notification, e.g., trail groomer ahead, other vehicle ahead, oncoming vehicle ahead, collision course alert; “follow me” notification to an operator from another operator, particularly another operator that is no longer visible due to dust, heavy rain, snow or other visually impairing condition; secondary engine RPM, ground speed, coolant temperature or battery charge indicator or alert.

Visual outputs of visual indicator device 606 may indicate a severity of the warning or notification. In an embodiment, a particular color, e.g., red, may indicate a high severity or urgency, which may correspond to a “warning” or an “SOS” alert. Other outputs may indicate a less severe or urgent situation, such as an information notification.

In an alternate embodiment, visual indicator device 606 may comprise a screen such as an LED, LCD or TFT screen, including a screen of HMI 208, providing visual indicators, such as colored regions, graphical icons, and so on.

Vibration devices 608, when present, and in an embodiment, may be embedded in graspable portion 610. Although two vibration devices 608 are depicted, in other embodiments, only one vibration device 608 may be present, and in other embodiments, more than two vibration devices 608 may be part of visual and haptic steering device 600. In vehicles 100 expected to be used in very rough terrain, a relatively larger number of vibration devices 608 may be used to ensure that the operator sense the haptic alert. In an embodiment, each vibration device 608 comprises a haptic transducer.

Vibration devices 608 may be connected to, and controlled by, a processor, such as a processor of ADAS 200, perception processor 514 of system 510, or other system or dedicated processor as described herein. Actuation of vibration devices 608 causes graspable portion 610 to also vibrate, which is detectable to an operator grasping graspable portion 610.

Vibration devices 608 may be configured to vibrate to communicate information that is the same as, or distinct from information communicated by visual indicator device 606. In an embodiment vibration devices 608 are configured and controlled to communicate the various warnings, alerts, and notifications as described above with respect to visual indicator device 606. In an embodiment, vibration devices 608 may be configured and controlled to produce vibrations of varying intensity and duration. These variations may be used to communicate different types of warnings and information, such as those described above with respect to visual indicator device 606.

In an alternate embodiment, rather than including vibration devices 608 embedded, or attached to, graspable portion 610, visual and haptic steering device 600 may be coupled to vibration-generating system 620, as depicted in FIG. 25.

Referring to FIG. 25, in an embodiment, vibrations or haptic sensations transmitted to an operator via graspable steering device 604 may be generated by vibration-generating system 620, rather than vibration devices 608.

In an embodiment, vibration-generating system 620 includes processor 622 connected to power steering unit 624 via CANBUS 626, and shaft 628 connected to graspable steering device or wheel 610.

In an embodiment, processor 622 is configured to determine whether a haptic alert is needed, such as a processor of ADAS 200 described previously. Processor 622 is connected to power steering unit 624, or components thereof, such as a motor controller 630 of vehicle 100, as described below.

Power steering unit 624, in an embodiment, and as depicted, includes motor controller 630 connected to motor 632 which delivers a physical, vibrational output to shaft 628. Motor controller 630 may be in communication with processor 622, receiving communication signals directing motor controller 630 to control the vibrational output of motor 632.

Graph 634a depicts vibrational output strength vs. time for a single warning event in a first embodiment, and graph 634b depicts vibrational output strength vs. time for the single warning event in a second embodiment.

As depicted in graph 634a, for a given warning event output strength or intensity increase gradually, then is held at a first constant high level, then decreases to a second, constant lower level. After a predetermined period of time, or after a need for the alert or warning passes, the output ends.

According to graph 634b, the output strength vs. time is substantially the same as that of graph 634a, however in the embodiment of system 620 according to graph 634b, the mechanical output is dithered, such that the output varies are a relatively high frequency. Such a dithered output may be more readily detected by an operator.

The mechanical, vibrational output of motor 632 is transferred through shaft 628, and to graspable steering device 610 for sensing by the operator.

As described above, a number of methods of alerting an operator of a vehicle 100 using a haptic steering device are enabled by system 620.

In an embodiment, and still referring to FIG. 25, a method 640 for alerting an operator of a vehicle using a haptic steering device includes steps 642 to 648. At step 642, processor 622 determines that the operator should be warned, and transmits a warning signal to motor controller 630. At step 644, motor controller 630 causes motor 632 to output a mechanical, vibrational output. At step 646, the mechanical vibrational output is transferred through shaft 628 to steering device 610, thereby alerting an operator. At step 648, processor 622 determines that the warning no longer needs to be issued, and directs motor controller 630 to cease output.

In another embodiment, and referring to the configuration of FIG. 24, a method 650 for altering an operator of a vehicle using a haptic steering device includes steps 652 to 658. At step 652, a processor, such as processor 622, or another vehicle processor, determines that an operator warning is required. At step 654, processor 622 transmits a control signal to vibration-generating devices 608. At step 656, vibration devices receive the control signal from processor 622 and vibrate. At step 658, vibrations from vibration devices 658 are transferred to steering device 610 for sensing by an operator grasping steering device 610.

In an embodiment, method 650 also includes the step of causing visual indicator device 606 to illuminate.

The systems, devices and methods of FIGS. 24 and 25 allow operators to keep their concentration on watching the terrain. As described, alerts, notifications, or other indicators can be sent to the operator or rider for detection using their hands on the steering wheel and/or indicator lights on the wheel. This is especially useful for vehicles 100 that have a center mounted gauge/display that requires an operator to rotate their head substantially to view. During intense riding the rider or operator will be focusing on the trail/terrain and may not be looking at their gauge/display for vehicle faults like engine overheating, transmission overheating, low battery conditions, or other vehicle faults or alerts. Consequently, utilizing visual and haptic steering device 600 can signal the rider that they need to look at their gauge or IVI to see a warning or notification.

Embodiments of the present disclosure not only include systems, devices and methods of detecting and warning riders of hazards and other trail or vehicle conditions, such as system 510, but also may include systems, methods and devices for tracking or monitoring locations of nearby vehicles.

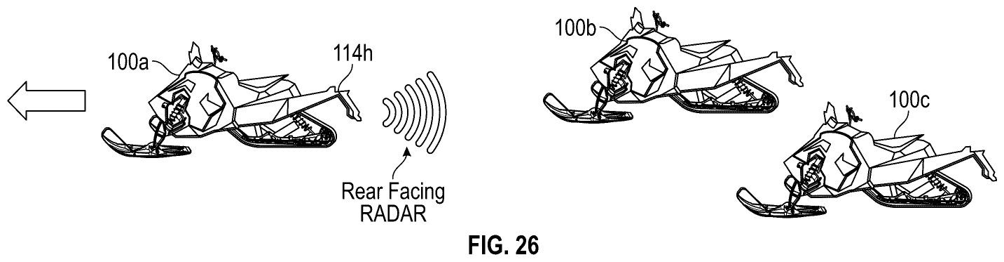

Referring to FIGS. 26-29, rearward-vehicle tracking and safety-zone system 700 and corresponding methods are depicted. Rearward-vehicle tracking and safety-zone system 700 shares many common features with system 510 for detecting, tracking and warning of hazardous objects while in opaque or limited-visibility conditions. However, system 700 may be optimized for detecting and tracking “hazards” in the form of other vehicles in close proximity, and particularly for other vehicles located rearwardly.

Referring specifically to FIG. 26, three vehicles 100 traveling in close proximity and in a direction indicated by the arrow are depicted. In this embodiment, each vehicle 100 is depicted as a snowmobile, though vehicle 100 may comprise other types of ORVs. Operators of vehicles/snowmobiles 100 often travel in groups, and often face limited-visibility trail conditions, or opaque environments, due to airborne snow, as described above with respect to system 510 for hazard detection in opaque conditions. Further, depending on trail and terrain conditions, snowmobiles 100 may travel at relatively high speeds. Consequently, being able to detect and monitor locations of other snowmobiles 100, particularly rearwardly, along with following distances or times, can increase the safety of all of the snowmobile operators and passengers in the group of snowmobiles.

As depicted in FIG. 26, a first snowmobile 100a is forward of two other snowmobiles, namely snowmobile 100b and snowmobile 100c. In an embodiment, lead snowmobile 100a includes an ADAS which includes rearward sensor 114h. In an embodiment rearward sensor 114h is a radar-based sensor that transmits electromagnetic waves and receives portions of reflected waves back at sensor 114h. In other embodiments, rearward sensor 114h may comprise other types of sensors and sensing technologies, as described above, e.g., lidar, infrared, etc. Although lead snowmobile 100a is the only vehicle depicted as having a rearward sensor 114h, it will be understood that one or more of the vehicles 100 following lead snowmobile 100a may also include system 700 with rearward sensor 114h.

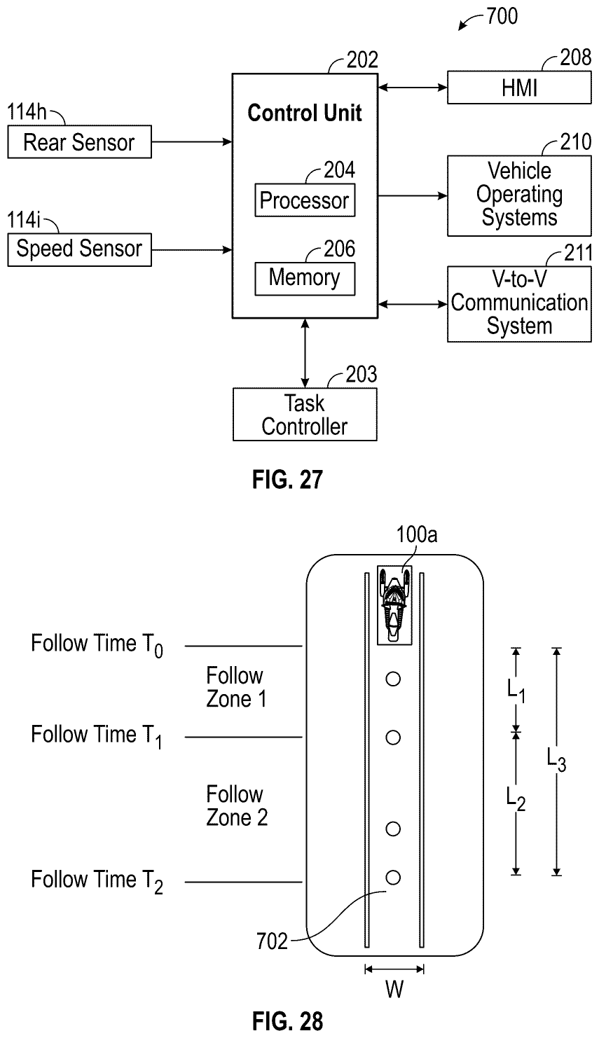

Referring also to FIG. 27, a simplified block diagram of rearward-vehicle tracking and safety-zone system 700 is depicted. Rearward-vehicle tracking and safety-zone system 700 may comprise an ADAS which is the same as, or similar to ADAS 200, as described above, such that features of ADAS 200 apply to ADAS/system 700.

In an embodiment, rearward-vehicle tracking and safety-zone system 700 includes rear sensor 114h, controller 202 with processor 204 and memory 206, task controller 203, HMI 208, and vehicle operating systems 210. These components are described above with respect to FIG. 7 and ADAS 200 above. In an embodiment, and as depicted system 700 also includes include speed sensor 114i that provides vehicle 100 speed data to controller 202 and vehicle-to-vehicle (V-to-V) communication system 211 that facilitates communication between vehicles 100. In an embodiment, system 700 may also include a geolocation device, such as a GPS device.

Generally, rearward-vehicle tracking and safety-zone system 700 is a smart detection system that actively monitors vehicle speed of the lead or primary vehicle 100a and the following vehicles, such as vehicles 100b and 100c, and constantly or regularly advises the operator of safe riding distances. As the group of vehicles 100 pick up speed, controller 202 receives and processes data from rear sensor 114h for detection of following vehicles and for following vehicle speed determination, and speed sensor 114i for determining a speed of lead vehicle 100a; in an embodiment, HMI 208 will automatically update and show time-based following intervals as opposed to actual physical distances to ensure proper safe following distances.

In an embodiment, HMI 208 displays icons representing a location of vehicles rearward of lead vehicle 100a, such as vehicles 100b and 100c, and provides recommended speed-based following distances or follow times to ensure operators in the ride group are following at adequate distances. If a following vehicle 100b or 100c is following lead vehicle 100a too closely, HMI 208 of lead vehicle 100a provides visual lighting or utilizes V-to-V communication system 211 to advise the following vehicle to slow down and increase a distance or follow time between lead vehicle 100a and the following vehicle 100b or 100c.

Referring to FIG. 28, an illustration of speed and time-based follow zones is depicted. Lead vehicle 100a is traveling at a speed S along travelled path 702, which in an embodiment, defines a width W. Follow Zone 1 is an area directly rearward of lead vehicle 100a in travelled path 702 having width W and length L1; Follow Zone 2 is an area adjacent to, and rearward of, Follow Zone 1, and has width W and length L2.

In an embodiment, Follow Zone 1 defines a region with a length or distance L1 that is not preferred, or is considered too close, i.e., if following vehicle 100b or 100c is within Follow Zone 1 and following at a distance L1 or less, then following vehicle 100b or 100c is too close to lead vehicle 100a. In contrast, Follow Zone 2 defines a region and following distance of at least L1 and as much as L3 (which is L1+L2) that is preferred, i.e., if following vehicle 100b or 100c is within Follow Zone 2 and therefore following at a distance of at least L1 and up to distance L3, then following vehicle 100b or 100c is acceptably distanced from lead vehicle 100a, and is following at a distance that is acceptably safe.

Although a width of each of Follow Zones 1 and 2 are described and depicted herein as being width W, the width of the zones could be less than or greater than width W. In an embodiment, a width of one or both of Follow Zones 1 and 2 is greater than width W so as to encompass a greater alert area.

In an embodiment, Follow Zones 1 and 2 may be defined as predetermined distances, regardless of lead vehicle 100a speed S. However, in an embodiment, Follow Zones 1 and 2 may be determined defined based on “follow times” T, with distances L1 and L3 dependent upon desired follow times T and speed S, as described further below.

Follow Times T are the respective amounts of time that a following vehicle 100b or 100c required to traverse the distance between the following vehicle 100b or 100c and the ground location corresponding to the rearward-most portion of lead vehicle 100a. In other words, each Follow Time T represents a time before impact if following vehicle 100b or 100c maintained a speed S and lead vehicle 100a was stopped. Follow Time TO is set equal to zero; Follow time T1 is the time needed to traverse Follow Zone 1 with its length L1; and Follow time T3 is the time needed to traverse both Follow Zones 1 and 2, or distance L3. In this embodiment, Follow Zones 1 and 2 are defined to correspond to a particular follow time, which determines a follow distance. This provides the advantage that as vehicle 100 speeds change, the amount of time that an operator or rider of a following vehicle has to react to a change in speed or direction of the lead is maintained, and in particular, is not cut short due to increased vehicle speed.

In an embodiment, Follow Times T1 and T2 are automatically set by controller 202; in another embodiment, an operator of vehicle 100 may manually select and set Follow Times T1 and T2. In an embodiment, Follow Time T2 is always an integer-multiple of Follow Time T1, such as T2=2X T1; in another embodiment, Follow Time T1 is in a range of 1 to 10 seconds and Follow Time T2 is in a range of 3 to 15 seconds; in another embodiment, Follow Time T1 is set to 3 seconds and Follow Time T2 is set to 6 seconds. It will be understood that the selection of Follow Times T1 and T2 may be determined by a number of factors, including operator preference, operator skill, vehicle power and/or speed capability, terrain characteristics, such as elevation change and/or the presence of obstacles such as trees and rocks, number of operators in a group, and so on.

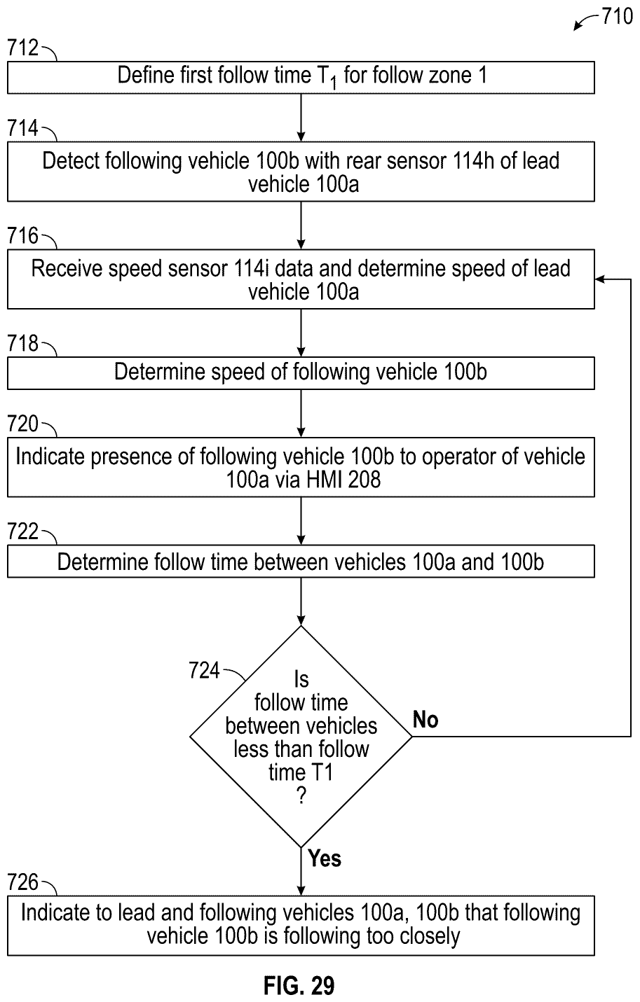

Referring also to FIG. 29, an embodiment of a method of rearward tracking and vehicle safety-zone establishing 710 is depicted and described in a flowchart.

At step 712, a first Follow Time T1 for Follow Zone 1 is determined. Follow Time T1 may be set by an operator of vehicle 100 or may be automatically set based on information saved in a memory of controller 202. In an embodiment, a second Follow Time T2 for a second Follow Zone 2 may be defined, or other follow times T may be defined, depending on the degree of tracking and monitoring desired.

At step 714, rearward sensor 114h communicates data to controller 202 or task controller 203 which determines or detects that a vehicle 100, such as vehicle 100b is following lead vehicle 100a.

At step 716, data from speed sensor 114i is transmitted to controller 202 which determines a speed of lead vehicle 100a. In an embodiment, this step is optional.

At step 718, using data from rearward sensor 114h provided to controller 202, a speed of following vehicle 100b is determined.

At step 722, a follow time between lead vehicle 100a and following vehicle 100b is determined. As described above, a follow time may be defined as a theoretical time that it would take following vehicle 100b to travel a distance between a front of following vehicle 100b to lead vehicle 100a if lead vehicle 100a were stationary. In an alternative embodiment, a follow time may be based on relative speeds, such that a follow time is defined as a theoretical time that it would take following vehicle 100b to travel the distance from following vehicle 100b to lead vehicle 100a if both vehicles were to maintain their respective speeds (which may or may not be the same).

At step 724, if the calculated or determined follow time between vehicles is less than the predetermined Follow Time T1, then following vehicle 100b is following too closely to vehicle 100a, and at step 726, HMI 208 indicates to at least lead vehicle 100a that following vehicle 100b is following too closely. In an embodiment, lead vehicle 100a with HMI 208 also provides an indication or warning to following vehicle 100b that it is following too close by sending a communication from lead vehicle 100a to vehicle 100b via V-to-V communication system 211.

In an embodiment, HMI 208 provides a “too close” indication or warning to an operator of vehicle 100a via visual, audible or haptic warnings as described above with respect to other systems.

If at step 724, the follow time is not less than the predetermined Follow Time T1, then the process reverts to step 716 and continues.

Other embodiments rearward tracking systems and methods may assist vehicle operators in certain trail conditions. Certain offroad trails are in regions where they intersect or run parallel to designated automotive vehicle roads/trails, sometimes in ditches or in the case of winter snowmobiling within 10 ft of road on level ground or sidewalks for periods. In order to prevent falsely sensing an on-road vehicle coming from behind the vehicle that is not even on the trail, certain methods and method steps may be helpful. First, on-road sensing systems can be employed via sensor fusion on vehicle 100 to allow the lead vehicle to understand where the boundaries are for on-road vehicles (optionally also/or using GPS mapping boundary data for roads as well as trails) and thus exclude detected rearward moving vehicle signatures from RADAR that fall in those zones. In an embodiment, V-to-V communications system 211 is configured to communicate with certain on-road communication systems used by vehicles, such as automobiles, that may be traveling on roadways.

Second, a speed vector of rearward detected vehicles may be tracked (not just it's velocity magnitude and position) such that even on tight turns where the rearward vehicles velocity appears smaller (because it's not instantaneously going in the same direction as lead vehicle) and erroneously not trigger a warning threshold when ideally it should. In order to understand how a vehicle's vector map on these turns (and deduce if it's path is likely to end up on the same path as lead vehicle) the path of the following vehicle must be understood, which could be learned via trail sensing systems & algorithms, which could combined with GPS trail data and/or lead vehicle(s) historical trail data (i.e. the path where the lead vehicle and others have ridden is most likely the path where following vehicles will ride even if we have no idea where the trail should be from sensors or trail maps).

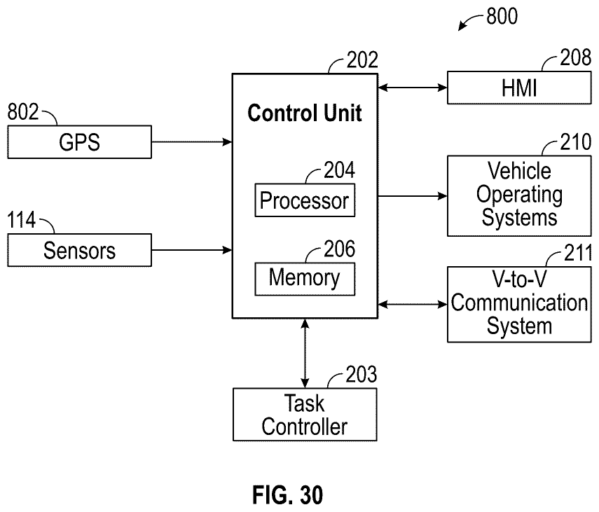

Referring to FIGS. 30-32, systems, devices and methods of warning ORV operators of out-of-sight traffic are depicted.

While trail riding, it is imperative for an operator of a vehicle 100 to be alert and attentive of his or her surroundings. One challenge trail riders face in particular is not knowing when oncoming traffic is present around a blind turn or over a hill or dune, or whether someone following is attempting to pass. This is due to the typical high-noise levels associated with ORVs, the attenuation of that noise via helmets and safety gear, and the overall riding environment in general. Embodiments of the present disclosure address such a challenge.

Referring specifically to FIG. 30, in an embodiment, a trail-alert system 800 includes geolocation device 802, which in an embodiment is a global positioning system (GPS) transmitter/receiver 802, in communication with controller 202 which includes processor 204 and memory 206. Trail-alert system 800 also includes HMI 208, vehicle operating systems 210 and V-to-V communication system 211. In an embodiment, Trail alert system 800 may also include a dedicated task controller 203 and various sensors 114.

In an embodiment, V-to-V communication system 211 may include one or more transmitters, receivers, transceivers, and so on, and be configured to transmit and receive long-range, relatively high frequency electromagnetic signals, which in an embodiment are in a range of 900 MHz and above. In other embodiments, V-to-V communication system 211 may operate in other frequency ranges, such as in a 433 mHz range as used by certain radio-frequency systems. In an embodiment, V-to-V communication system 211 transmits periodic signals and looks for signals not sent from the transmitting vehicle, i.e., that are transmitted from another vehicle. In such an embodiment, system 211 may integrate with, and share data with, an on-road vehicle operating on a roadway, rather than another off-road vehicle. In an embodiment, communication system 211 is configured to dynamically mesh with radio signals of other vehicle communications encountered or detected to leverage different communication systems.

Trail-alert system 800 increases the operator's attentiveness when in close proximity to others and alerts them of oncoming traffic without that traffic being in line-of-sight. This enables the operator to have enough time to move to a safe path to avoid collision, or slow down knowing that someone is attempting to pass them from behind. Understanding where other out-of-sight vehicles are located dramatically increases operator safety, particularly on off-road trails with heavy traffic and limited sight lines.

In operation, a precise GPS location, which in an embodiment is accurate to within 10 cm or less, is transmitted wirelessly from each vehicle 100 or ORV via V-to-V communication system 211. By calculating the distance between points at a known frequency, a primary or host vehicle speed can be calculated, or read directly from the vehicle itself. Based on a set of calibrations, or an operator input to define sensitivity of the alert (i.e. high, medium, low), a virtual dynamic boundary is determined and “placed” around the host vehicle to create a virtual vehicle zone or region. In an embodiment, a size of the virtual vehicle zone is based in part on the vehicle's speed/velocity, i.e., a higher velocity results in a larger region and a lower velocity results in a relatively smaller region.

If a target vehicle (one that is oncoming or attempting to pass) signal is detected and shown to be within the vehicle region of the host vehicle, an alert can be presented to the operators of both vehicles by means of audible, visual or haptic feedback or any combination of the three.

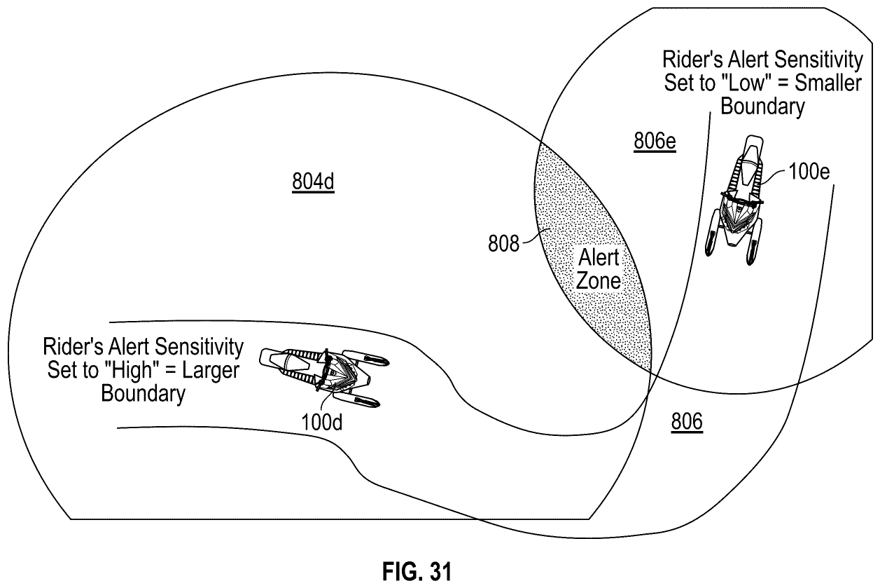

Referring also to FIG. 31, a pair of vehicles 100, both equipped with trail-alert 800, each with respective virtual vehicle zones 804, on trail 806 is depicted. Although FIG. 31 depicts snowmobiles, it will be understood that vehicles 100 may comprise other ORVs. First vehicle 100d is traveling at a first rate of speed that results in or corresponds to a relatively larger first virtual vehicle zone 804d; second vehicle 100e is traveling at a second rate of speed that is less than the first rate of speed, such that second virtual vehicle zone 804e is smaller than first virtual vehicle zone 804d. An area where first virtual vehicle zone 804d overlaps with second virtual vehicle zone 804e defines alert zone 808.

As described above, a virtual vehicle zone 804 size may be determined based on speed, with higher speeds corresponding to larger virtual vehicle zones 804, and vice versa. Further, in an embodiment, a shape of virtual vehicle zone 804 may comprise a generally circular shape such that a distance from vehicle 100 to any point on the boundary or outer limits of a corresponding virtual vehicle zone 804 is the same. In other embodiments, virtual vehicle zone 804 may form other shapes, such as an oval, which creates longer frontward and rearward distances from vehicle 100 to a boundary of the virtual vehicle zone 804. In some embodiments, vehicle 100 is virtually positioned in a center of virtual vehicle zone 804, though in other embodiments vehicle 100 is virtually positioned off center, such as rearward, to create a longer frontward region and shorter rearward region.

In the depiction of FIG. 31, trail 806 forms a blind curve, such that the operator of vehicle 100d cannot literally see vehicle 100e, and the operator of vehicle 100d cannot see vehicle 100d. Without the aid of trail-alert system 800, a collision may occur. However, in an embodiment, as vehicles 100d and 100e approach each other, their respective virtual vehicle zones 804d and 804e overlap in the common area that is alert zone 808. Upon overlapping, each system 800 will detect the other vehicle, and cause an HMI 208 of each vehicle to alert its respective operator of the presence of the other vehicle 100. The respective systems 800 may be aware of each other through sharing of GPS data via V-to-V communication system 211. In an embodiment, HMI 208 may also provide an indication of a location of the other, oncoming vehicle, which may be a visual, audible and/or haptic alert or warning as described above. In an embodiment, HMI 208 displays a relative location of the oncoming vehicle on a display screen such that the operator is alerted to the location of the oncoming vehicle.

In an alternate embodiment, only one vehicle 100, such as 100d may include trail-alert system 800, while an encountered or oncoming vehicle, such as vehicle 100e may not include a trail-alert system 800 or a virtual vehicle zone. In such an embodiment, vehicles 100d and 100e may not be in communication with each other, and vehicle 100d may not alert to vehicle 100e until vehicle 100e has entered first virtual vehicle zone 804d. System 800 of vehicle 100d may detect vehicle 100e prior to vehicle 100e being visible to the operator of vehicle 100d by means of sensors 114 that do not require a “line of sight.” Such sensors 114 may include an audio sensor that detects engine or other vehicle noise or particular electromagnetic signatures emitted by an oncoming vehicle. In one embodiment, sensors 114 detect an electromagnetic signature or output of an engine component or operation, such as an ignition spark signature.

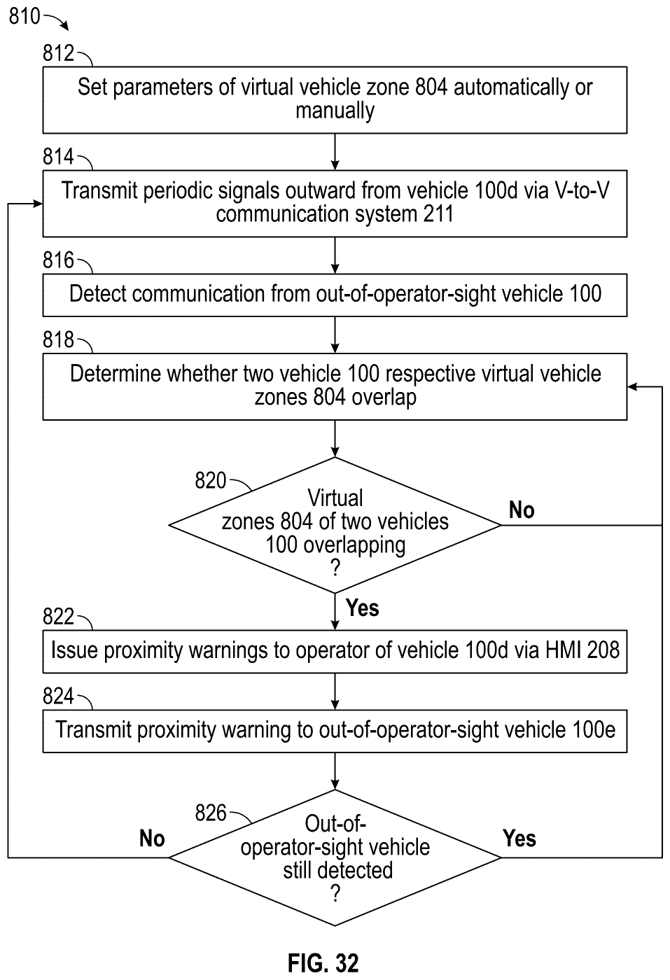

Referring to FIG. 32, method 810 of detecting and warning ORV operators of oncoming, out-of-sight vehicles is depicted and described. In this embodiment, as described in part above, two vehicles 100 (100d, 100e) both include a V-to-V communication system 211.

At step 812, parameters of virtual vehicle zone 804, such as size and shape, are set automatically by trail-alert system 800 of vehicle 100, such as vehicle 100d, or are set manually in whole or in part by an operator of vehicle 100.

At step 814, first vehicle 100d transmits a communication signal, which may be a periodic signal, using vehicle 100d V-to-V communication system 211. As also described above, the transmitted communication signal may comprise a relatively high-frequency or long-range signal. The transmitted communication signal may include a variety of data, including vehicle 100d profile information, a request to link to another vehicle, proximity zone parameters, and so on.

At step 816, vehicle 100d detects a communication signal from another vehicle 100 that is out of sight, which in this embodiment, is second vehicle 100e.

At step 818, controller 202 processes information of the received communication signal from second vehicle 100e to determine whether the respective virtual vehicle zones 804d and 804d overlap to create an “alert zone” 808. The information processed may include information relating to both first and second vehicles 100d and 100e. Information processed from the received communication signal from second vehicle 100e may include virtual vehicle zone 804e parameters, vehicle 100e speed, location, vehicle type and so on, as also described above. Information processed from the received communication signal from first vehicle 100d may include virtual vehicle zone 804d parameters, vehicle 100d speed, location, vehicle type and so on, as also described above.

At step 820, if virtual vehicle zones 804d and 804e are not overlapping, then the process reverts back to step 818 to continue monitoring for zone overlap.

At step 820, if virtual vehicle zones 804d and 804e are overlapping, then warnings are issued at step 822. In an embodiment, HMI 208 of vehicle 100d issues a visual, audible and/or haptic warning to the operator of 100d. In an embodiment, HMI 208 of the other vehicle, vehicle 100e may also issue a warning to the operator of vehicle 100e. In an embodiment, the warning may include various information as described above, such as relative vehicle location, speed, type, and so on.

At step 824, in an optional embodiment, vehicle 100d may transmit a warning to the operator of the out-of-operator-sight vehicle 100e via V-to-V communication system 211. The transmitted warning may include any of the warning information of step 822.

At step 826, if out of-operator-sight vehicle 100e is still detected, the monitoring process continues, reverting back to step 818. If at step 826, out-of-sight vehicle 100e is no longer detected by vehicle 100d, the process reverts back to step 814 for continued monitoring of the same or other vehicles 100e.

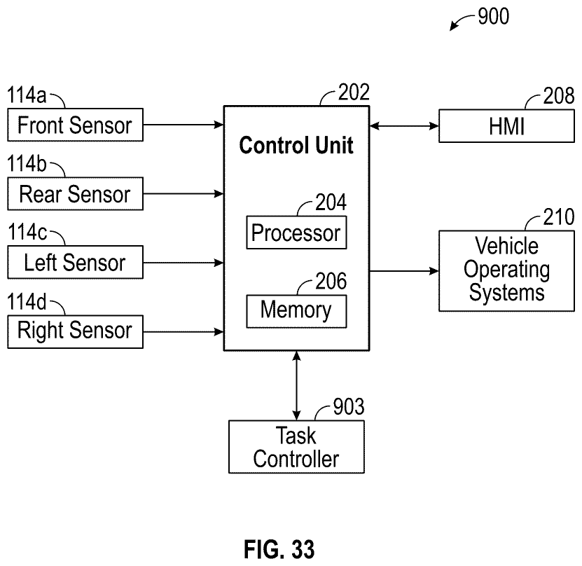

Referring to FIGS. 33-36, another semi-autonomous embodiment for aiding operators in operating their ORVs, reorientation-planning system 900, is depicted and described. Generally, ORV operators are increasingly in need of features providing greater vehicle agility that enable tighter maneuvering in small spaces. Key to performing tight maneuvers successfully in a short time is the ability for the operator to understand the local terrain features with very precise positioning. However, the operator often lacks visual data of objects around the vehicle due to vehicle obstruction. Further, ORVs, and in particular, side-by-side vehicles, are getting increasingly bulky with each passing year, leading to more trail riding or utility conditions where the driver needs external assistance, or must get in and out of the vehicle to reorient/turn around a vehicle.

As described in further detail below, embodiments of a reorientation-planning system 900 and related methods and devices can estimate local terrain in a 3600 view, and calculate, given known vehicle geometry and turn radius restrictions, the point or points at with vehicle 100 should pivot on to successfully change direction most optimally and guide the user step-by-step.

Reorientation-planning system 900 enables vehicle 100 to understand the immediately adjacent or surrounding (“local”) terrain features, such as, for example, within 10 ft. of vehicle 100, at virtually all times and with better distance accuracy than a human operator. In addition, HMIs 208 with heads-up displays allow clear communication of the terrain to the operator, along with recommendations for navigation.

In an embodiment, and as described in further detail below, turnaround-planning system 900 includes multiple sensors 114 to map the terrain near vehicle 100 identifying impassable terrain and otherwise risky spots, and conveying such information to the operator. Such impassable terrain may include objects, obstacles or portions of terrain representing a substantial change in terrain height above a predetermined terrain-height threshold. Under certain terrain conditions, such as when one or more difficult or risky spots is identified, reorientation-planning system 900 may suggest a reorientation/turnaround set of instructions to the operator, overlaying the path and direction-changes at each point in the plan on a heads up display of an HMI 208. In an embodiment, reorientation-planning system 900 may suggest a revised reorientation set of instructions during the reorientation process, based on additional input detected or otherwise received during the reorientation process.

In an embodiment, the operator may prompt with an input the request to change orientation or turn around. Such a prompt could be actuation of a simple set of digital input buttons or else system 900 could prompt for an input from the operator when a detected vehicle speed is below a threshold speed. In another embodiment, the operator could drag/drop a virtual vehicle onto a digital map showing the intended final vehicle 100 position and orientation. In a next step reorientation-planner system 900 computes the optimal step sequence to execute the operator's goal and displays this to the operator, optionally highlighting direction change points along with steering angle and distance-to-stop points. In an embodiment, the operator may be able to click on detected obstacles on the display, thereby influencing the path planner (such as a bush) and specify that the path planner ignore the selected objects in the plan such that they may be driven over and the system may be able to learn from the operator's corrections on interpreting the ability of vehicle 100 to drive over such objects in a future encounter.

Since the usefulness of this mode would be in managing very tight areas where precise positioning is key, feedback around instantaneous steering angle could be shown to the user in various ways, such as is depicted in the figures. In an embodiment, an actual steering angle vs. ideal or recommended steering angle is shown, though an operator still has control of the steering angle.

In some embodiments, when determining pivot points and steering angles, reorientation-planning system 900 may take into account an attached trailer or other vehicle attachments, e.g., a plow, with known and/or learned characteristics such as geometry and weight.

Referring specifically to FIG. 33, an embodiment of a block diagram of turnaround-planning system 900 is depicted. In an embodiment, system 900 includes substantially the same basic components as ADAS 200 as depicted in FIG. 7, though configured differently to accomplish the reorientation methods described below.

In an embodiment, reorientation-planning system 900 of vehicle 100 includes control unit 202 with processor 204 and memory device 206 in communication with a plurality of sensors 114, HMI 208 and vehicle operating systems 210. In an embodiment, reorientation-planning system 900 may also include an additional controller, task controller 903 for processing data related to the reorientation-planning features described herein, and a geolocation device, such as a GPS receiver.

As described above, sensors 114 may comprise any of a variety of sensors, and particularly radar, lidar or infrared. In the embodiment depicted, reorientation-planning system 900 includes four sensors, namely, a front, rear, left and right sensor 114a, 114b, 114c and 114d, respectively. However, in other embodiments, more or fewer sensors 114 may be included. In an embodiment, reorientation-planning system 900 includes a sufficient number of sensors to sense and detect terrain and objects all around vehicle 100, such that terrain is detected and mapped in a 360° range entirely around vehicle 100.

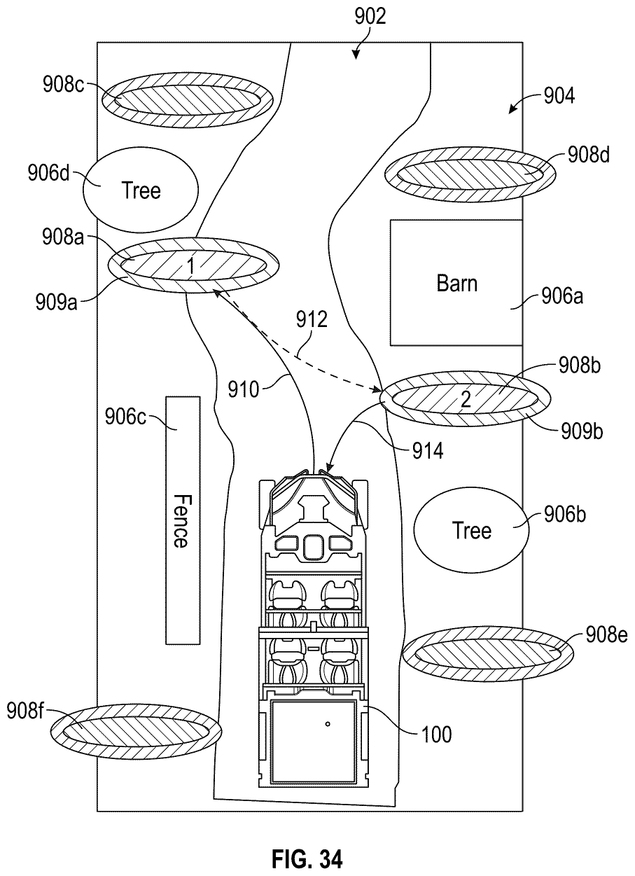

Referring also to FIG. 34, a graphical view of vehicle 100 on trail 902 in region 904 is depicted. The graphical view or representation of FIG. 34 may be displayed to an operator of vehicle 100 via HMI 208. Region 904 includes multiple terrain features or objects 906 to be avoided by vehicle 100, including terrain feature 906a, 906b, 906c and 906d, which as depicted represent a barn, first tree, fence and second tree. Terrain features 906 may comprise natural features such as trees, shrubs, grasses, rocks, dirt and so on, or man-made features, such as buildings, fences, stationary vehicles and other man-made objects.

Also depicted in region 904 are multiple pivot points 908, including pivot points 908a, 908b, 908c, 908d, 908e and 908f. Generally, each pivot point 908 represents a point where vehicle 100 is intended to pivot or turn so as to change direction. In an embodiment, a pivot point 908 is also a point where vehicle 100 stops and changes a forward or rearward direction, as well as changing a leftward or rightward direction. In an embodiment, each pivot point 908 is defined by a specific geolocation that may be defined by GPS coordinates, or some other coordinate system. Further, although described as a “point,” a pivot point 908 may also include an area surrounding each specific, single point location, as depicted in FIG. 34. Graphically, each pivot point 908 may be depicted as a small point, or in other embodiments, and as depicted, may be defined by, and represented as, a larger defined area the includes a precise geolocation. In the embodiment depicted, each pivot point 908 is depicted as an oval area that vehicle 100 should be guided to in order to accomplish the reorientation.

Further, each pivot point 908 may be located in a larger pivot region 909. Each pivot region 909 represents an area throughout which the corresponding pivot point 908 may be moved or relocated. Each pivot region 909 is depicted as a shaded border around, and including, its respective pivot point 908. First pivot region 909a for first pivot point 908a and second pivot region 909b for second pivot point 908b are depicted. In an embodiment, the graphical display of vehicle 100 in region 904 may be displayed on a touch screen of HMI 208, with available pivot points 908 within pivot regions 909, thereby indicating that the displayed pivot points 908 may be dragged to a point to anywhere within that corresponding pivot region 909.

In an embodiment, reorientation-planning system 900 initially recommends one or more pivot points, such as a first pivot point 908a and a second pivot point 908b. Alternate pivot points may be identified by system 900, and may be displayed to the operator, such as first alternate pivot point pair 908c and 908d, and second alternate pivot point pair 908e and 908f. In an embodiment, if the operator of vehicle 100 prefers the alternate pivot points, the operator may simply proceed to one of the alternate pivot points, and system 900 may dynamically identify and display one or more of the alternate pivot points 908, e.g., 906c, as the highlighted and preferred pivot point, rather than the initially recommended pivot points, e.g., 908a.

In an embodiment, a second pivot point 908b is determined only after a first pivot point 908a is selected. In such an embodiment, the second pivot point 908b is calculated by task controller 903, or by controller 202, after the operator has selected the first pivot point 908a.

In addition to providing available pivot points 908, reorientation-planning system 900 may also provide instructions to the operator of vehicle 100, including by displaying directional arrows on the display screen, as depicted in FIG. 34, for directing and guiding vehicle 100. In this depiction and embodiment, HMI 208 displays three graphical arrows 910, 912 and 914, which if followed by vehicle 100 would result in vehicle 100 making a three-point turnaround. Arrows 910 and 914 represent a forward direction, and may be color coded or otherwise distinguished from arrow 912, which represents a reverse direction.

To accomplish the recommended 3-point turnaround in the illustration of FIG. 34, an operator, in an embodiment, may manually direct vehicle 100 in a generally forward and leftward direction until a portion of vehicle 100, which may be a front portion, or another portion, is over or on first pivot point 908a. In an embodiment, a user interface communicates a nominal distance from the vehicle to the pivot point, such as by displaying an on-screen number optionally in combination with a notification graphic. Vehicle 100 may then be placed into a reverse gear, and be driven rearwardly and toward second pivot point 908b until a portion of vehicle 100 is at or on second pivot point 908b. Vehicle 100 may then be placed into a forward gear again, and be driven forward and away from second pivot point 908b and onto trail 902 in a direction opposite to the original direction or orientation of vehicle 100.

In an embodiment, the operator of vehicle 100 manually operates vehicle 100, steering, accelerating and braking as needed to move between pivot points 908. In another embodiment, the reorientation or turnaround process is more autonomous. In an embodiment, controller 202 of reorientation-planning system 900 may be configured for autonomous control of vehicle 100, communicating with vehicle operating systems 210, such as a drivetrain system, acceleration system, steering system and braking system. In such an embodiment, the operator of vehicle 100 may simply select an option to actuate or turn on a toggle to implement an autonomous reorientation or turnaround process, similar to the parking processes described above with respect to other embodiments of the disclosure.

In an embodiment, reorientation-planning system 900 monitors and detects actual movement of vehicle 100 to determine whether deviations from the recommended plan will still allow vehicle 100 to be reoriented. In an embodiment, if vehicle 100 is maneuvered to not follow the recommended plan, system 900 may notify the operator and/or suggest a revised plan.

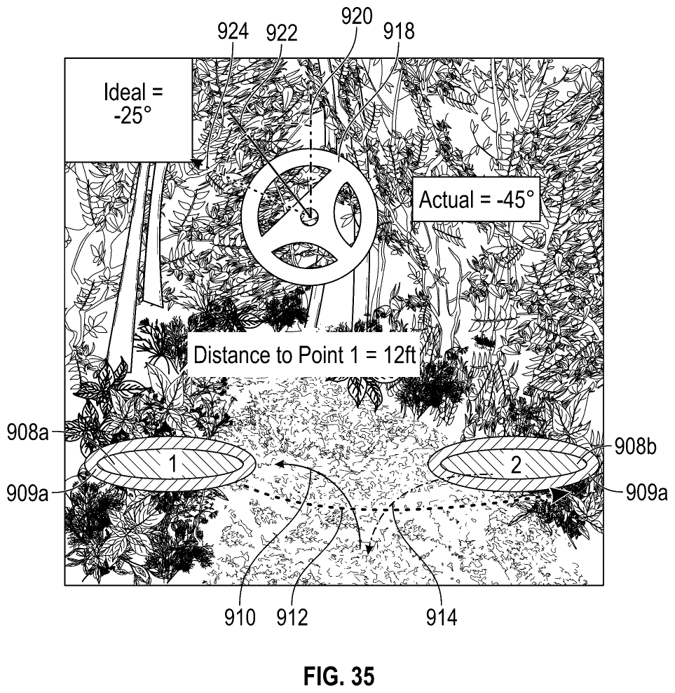

Referring to FIG. 35, in another embodiment, rather than, or in addition to, displaying pivot points 908, pivot regions 909 and directional arrows 910, 912 and 914 on a display screen, such as a touch screen, these graphical icons may displayed by a heads-up display, as depicted. In the depicted embodiment, and as explained further below, a graphical steering-wheel icon 918 and steering-angle indicators 920, 922 and 924 are also displayed.

In an embodiment, steering angle indicator 920 is a reference line a indicating 0° steering angle; steering angle indicator 922 indicates an ideal steering angle for vehicle 100 that would steer vehicle 100 to a pivot point, such as pivot point 908a; and steering angle indicator 924 indicates an actual steering angle for vehicle 100, based on steering angle data provided by a steering angle sensor 114 of vehicle 100 processed by task controller 903 or controller 202.

An ideal steering angle is determined by task controller 903 or controller 202 based on the determined pivot point 908 location data, location of vehicle 100, and in some embodiments, an ideal path from the location of vehicle 100 to pivot point 908, which may be represented by a directional arrow, such as arrow 910.

By displaying steering angle information, and in particular, actual vs. ideal steering angle, reorientation-planning system 900 makes it easy for an operator to rotate the steering wheel and accurately drive vehicle 100 to pivot point 908.

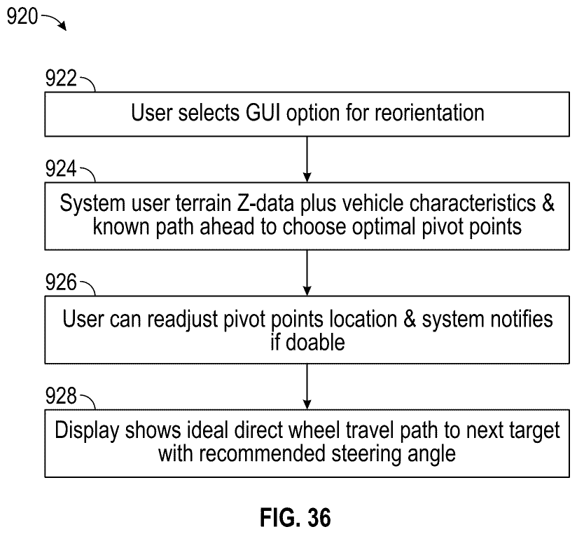

Referring to FIG. 36, method 920 for changing an orientation of a vehicle in a constrained space.

At step 922, an operator of vehicle 100 selects an option of vehicle 100 to perform a reorientation or turnaround maneuver or pivot. In an embodiment, selecting the option for the turnaround maneuver includes selecting a graphical icon displayed on a touch-screen display of HMI 208. In other embodiments, the operator may actuate a physical switch or otherwise initiate a reorientation maneuver.

At step 924, reorientation-planning system 900 receives and processes terrain data, such as elevation data, or “z” data, along with known vehicle characteristics and path or trail information in the vicinity of vehicle 100, to determine optimal pivot points. In an embodiment, reorientation-planning system 900 determines more than one set of available pivot points.

At step 926, a user or operator optionally changes the recommended pivot points 908, followed by system 900 notifying the operator whether the pivot points changed by the operator will accomplish the reorientation maneuver. If not, the operator may propose other pivot points, or select the system-recommended pivot points.

At step 928, HMI 208 of vehicle 100 displays directional indicators, such as directional arrows 910, 912, and/or 914, and in an embodiment, may also display an ideal or recommended vehicle steering angle.

Clause 1. A method for autonomously loading an off-road vehicle (ORV) having a vehicle controller in communication with a vehicle sensor, a plurality of vehicle operating systems and a human-machine interface (HMI), onto a platform of a transport vehicle, including: detecting a loading ramp associated with the transport vehicle using the vehicle sensor; determining whether the ORV will fit onto the loading ramp based on data provided by the vehicle sensor; determining an inclination angle of the loading ramp relative to the vehicle platform; and controlling one of the plurality of vehicle operating systems using the vehicle controller to cause the vehicle to accelerate up the loading ramp.

Clause 2. The method of clause 1, wherein controlling one of the plurality of vehicle operating systems using the vehicle controller includes calculating a vehicle acceleration.

Clause 3. The method of clause 2, further including activating a drive gear of the vehicle.

Clause 4. The method of clause 3, further including causing the vehicle to brake at or before reaching a docked position on the platform.

Clause 5. The method of clause 1, further including detecting objects in a vicinity of the vehicle and maintaining a predetermined distance from the detected objects.

Clause 6. The method of clause 1, further including detecting an item indicating a docking position, and stopping the vehicle at a docking position based on the item.

Clause 7. The method of clause 6, wherein the item comprises one of a magnetic device and a printed QR code.

Clause 8. A method for autonomously unloading an off-road vehicle (ORV) having a vehicle controller in communication with a vehicle sensor, a plurality of vehicle operating systems and a human-machine interface (HMI), from a platform of a transport vehicle, including: detecting a loading ramp associated with the transport vehicle using the vehicle sensor; determining whether the ORV will fit onto the loading ramp based on data provided by the vehicle sensor; determining an inclination angle of the loading ramp relative to the vehicle platform; and controlling one of the plurality of vehicle operating systems using the vehicle controller to cause the vehicle to accelerate down the loading ramp.

Clause 9. The method of clause 8, further including: calculating a vehicle acceleration, activating a drive gear of the vehicle, and causing the vehicle to brake after moving off of the loading ramp.

Clause 10. A method for autonomously parking an off-road vehicle (ORV) having a vehicle controller in communication with a vehicle sensor, a plurality of vehicle operating systems and a human-machine interface (HMI), onto a transport vehicle, including: visually detecting using an image located on the transport vehicle using the vehicle sensor, the image including information corresponding to a docking location of the vehicle on the transport vehicle; transmitting image data from the vehicle sensor to the vehicle controller; processing the image data to determine the information corresponding to the docking location using the vehicle controller, including determining a predetermined docking distance of the vehicle to the detected image; controlling operation of the vehicle causing the vehicle to move from an initial position toward a docked position; determining that the vehicle is located at the docked position and at the predetermined docking distance from the detected image; and controlling a braking system of the vehicle to cause the vehicle to stop at the docked position.

Clause 11. The method of clause 10, further including initiating a parking sequence.

Clause 12. The method of clause 10, wherein the image comprises a printed image that includes a readable bar code.

Clause 13. The method of clause 12, wherein the printed image includes a quick response (QR) code.

Clause 14. The method of clause 10, further including determining a distance of the vehicle to the image.

Clause 15. The method of clause 10, wherein determining a distance of the vehicle to image includes determining a number and size of image pixels of the image.

Clause 16. A method of controlling a vehicle using operator gestures, including: capturing multiple images of a vicinity around the vehicle using an image-capturing sensor of the vehicle; transmitting the image data of the multiple images from the image-capturing sensor of the vehicle to a computer processor associated with the vehicle; analyzing the image data of the multiple received images from the image-capturing sensor of the vehicle to detect whether an operator of the vehicle is making vehicle-control gestures; associating the detected vehicle-control gesture with a vehicle-control command; and causing the vehicle to execute the vehicle-control command associated with the detected vehicle-control gesture.

Clause 17. The method of clause 16, wherein capturing multiple images of a vicinity around the vehicle using an image-capturing sensor of the vehicle includes using a camera system to capture multiple images in multiple camera views.

Clause 18. The method of clause 16, wherein analyzing the image data to detect whether an operator of the vehicle is making vehicle-control gestures includes comparing the image data to image data stored in a memory device, the stored image data defining a plurality of predetermined vehicle-control gestures.

Clause 19. The method of clause 18, wherein associating the detected vehicle-control gesture with a vehicle-control command includes using a look-up table having pairs of vehicle-control gestures and corresponding vehicle-control commands, the look-up table stored in a memory device associated with the vehicle.

Clause 20. The method of clause 16, wherein causing the vehicle to execute the vehicle-control command associated with the detected vehicle-control gesture includes transmitting the vehicle-control command from a vehicle controller to a vehicle operating system.

Clause 21. The method of clause 20, wherein the vehicle operating system is one of an acceleration system, steering system and braking system.

Clause 22. The method of clause 16, further including sensing that the operator has exited the vehicle prior to causing the vehicle to execute the vehicle-control command.

Clause 23. A method of autonomously controlling a vehicle using a remote-control device, including: receiving a first communication signal from the remote-control device at a sensor of the vehicle; detecting a location of the remote-control device relative to a location of the vehicle based on the first communication signal received from the remote-control device; causing a graphical user interface (GUI) to be displayed on a screen of the remote-control device, the GUI displaying a graphical representation of the vehicle and selectable icons representing available directions for vehicle motion, and a location of the remote-control device or operator relative to the vehicle; receiving a second communication signal from the remote-control device requesting that the vehicle move in an operator-selected direction; and causing the vehicle to move in the operator-selected direction.

Clause 24. The method of clause 23, wherein receiving a first communication signal from the remote-control device at a sensor of the vehicle includes receiving a first communication signal over a wireless network.

Clause 25. The method of clause 23, further including determining an orientation of the vehicle relative to the remote-control device location.

Clause 26. The method of clause 25, further including displaying the orientation of the vehicle relative to the remote-control device on the screen of the remote-control device.

Clause 27. The method of clause 23, wherein displaying a graphical representation of selectable icons representing available directions for vehicle motion includes displaying graphical arrows pointing in the available directions for vehicle motion.

Clause 28. The method of clause 23, wherein causing the vehicle to move in the operator selected direction includes transmitting a vehicle motion request to an on-board vehicle controller, followed by the on-board vehicle controller transmitting a control command to a vehicle operating system.

Clause 29. The method of clause 23, wherein the vehicle operator system comprises a powertrain system or vehicle engine.

Clause 30. The method of clause 23, further including detecting that the operator has exited the vehicle.

Clause 31. A method of detecting and warning an operator of an off-road vehicle of objects in limited-visibility environments, including: detecting a potentially-hazardous object within the vicinity of the vehicle, using a sensor of the vehicle; transmitting data relating to the potentially-hazardous object to a vehicle processor; determining whether the potentially-hazardous object is in a projected path of the vehicle or in a proximity zone of the vehicle; and alerting the operator of the vehicle to the presence and location of the potentially-hazardous object when the potentially-hazardous object is in the projected path of the vehicle or in the proximity zone of the vehicle.

Clause 32. The method of clause 31, further including detecting a limited-visibility environment in a vicinity of the vehicle, the limited-visibility environment caused by airborne particles such as airborne dust, snow or rain.

Clause 33. The method of clause 32, wherein detecting airborne dust, snow or rain includes using the sensor of the vehicle used to detect the potentially-hazardous object.

Clause 34. The method of clause 32, wherein detecting airborne dust, snow or rain includes using a sensor of the vehicle other than the sensor of the vehicle used to detect the potentially-hazardous object.

Clause 35. The method of clause 31, wherein detecting a potentially-hazardous object within the vicinity of the vehicle, using a sensor of the vehicle includes using a radar or lidar sensor.

Clause 36. The method of clause 31, wherein determining whether the potentially-hazardous object is in a projected path of the vehicle includes determining the projected path of the vehicle using a geolocation device of the vehicle.

Clause 37. The method of clause 31, wherein determining whether the potentially-hazardous object is in a proximity zone of the vehicle includes defining a proximity zone that defines a geographical region around the vehicle.

Clause 38. The method of clause 37, wherein defining a proximity zone that defines a geographical region around the vehicle includes defining a geographical area in front of, and behind, the vehicle.

Clause 39. The method of clause 31, wherein alerting the operator of the vehicle to the presence and location of the potentially-hazardous object includes issuing a visual, audible or haptic warning to the operator.

Clause 40. The method of clause 39, wherein includes issuing a visual warning to the operator includes displaying a warning on a display screen of a human-machine interface of the vehicle.

Clause 41. The method of clause 39, wherein issuing a haptic warning to the operator includes causing handlebars or a steering wheel of the vehicle to vibrate.

Clause 42. The method of clause 31, further including displaying the potentially-hazardous object on a display screen of a human-machine interface of the vehicle.

Clause 43. The method of clause 42, wherein displaying the potentially-hazardous object on a display screen of a human-machine interface of the vehicle includes displaying a map of the vicinity and displaying the potentially-hazardous object on the map.

Clause 44. A method of alerting an operator of an off-road vehicle, including; determining whether to issue a warning to an operator of the off-road vehicle; transmitting a control signal to a mechanical vibration-generating device in mechanical connection with a graspable steering device of the off-road vehicle; generating a mechanical vibration output from the mechanical vibration-generating device based on the transmitted control signal; and transferring the mechanical vibration output to the graspable steering device of the off-road vehicle via mechanical contact, thereby alerting the operator of the off-road vehicle.

Clause 45. The method of clause 44, wherein transmitting a control signal to a mechanical vibration-generating device in mechanical connection with a steering device of the off-road vehicle includes transmitting a control signal from a warning system of the off-road vehicle.

Clause 46. The method of clause 44, wherein generating a mechanical vibration output from the mechanical vibration generating device includes generating a mechanical vibration output from the mechanical vibration generating device embedded in the graspable steering device.

Clause 47. The method of clause 46, wherein the mechanical vibration generating device is a haptic transducer.

Clause 48. The method of clause 44, wherein generating a mechanical vibration output from the mechanical vibration generating device includes generating a mechanical vibration output from the mechanical vibration generating device connected to the graspable steering device via a steering shaft.

Clause 49. The method of clause 44, wherein generating a mechanical vibration output from the mechanical vibration-generating device includes generating a first mechanical vibration output from a first mechanical vibration-generating device located at a first position at the graspable steering device and generating a second mechanical vibration output from a second mechanical vibration-generating device located at a second position at the graspable steering device.

Clause 50. The method of clause 49, wherein the first position is at a left-side of the graspable steering device, and the second position is at a right-side of the graspable steering device.

Clause 51. The method of clause 50, further including generating the first mechanical vibration output at a time that is different from a time that the second mechanical vibration output is generated, and the first mechanical vibration corresponds to a first alert message and the second mechanical vibration corresponds to a second alert message.

Clause 52. The method of clause 51, wherein the first alert message indicates that the operator should turn left and the second alert message indicates that the operator should turn right.

Clause 53. The method of clause 44, further including causing a visual indicator to issue a visual alert in response to the determination of whether to issue a warning to an operator of the off-road vehicle.

Clause 54. A method of rearward tracking of off-road vehicles, including: defining a first follow time for a first follow zone, the first follow time being a time duration required to traverse a length of the first follow zone; detecting at a lead off-road vehicle an off-road vehicle following the lead vehicle using a rearwardly-sensing sensor on the lead off-road vehicle; receiving speed sensor data from a speed sensor of the lead off-road vehicle, and determining a speed of the lead off-road vehicle based on the speed sensor data; determining a follow time of the off-road vehicle following the lead off-road vehicle; comparing the follow time of the off-road vehicle to the defined first follow time; and issuing a warning via a human-machine interface (HMI) of the lead off-road vehicle, the warning indicating that the off-road vehicle following the lead vehicle is within the first follow zone.

Clause 55. The method of clause 54, wherein defining a first follow time for a first follow zone includes an operator manually defining the first follow time by interfacing with the HMI.

Clause 56. The method of clause 54, wherein defining a first follow time for a first follow zone includes a controller of the lead off-road vehicle defining the first follow time for a first follow zone based on the speed of the lead off-road vehicle.

Clause 57. The method of clause 54, wherein the first follow zone is determined based on the first follow time a speed of the lead off-road vehicle.

Clause 58. The method of clause 54, wherein detecting at a lead off-road vehicle an off-road vehicle following the lead vehicle using a rearwardly-sensing sensor on the lead off-road vehicle includes using a radar-based sensor on the lead off-road vehicle.

Clause 59. The method of clause 54, wherein issuing a warning via an HMI of the lead off-road vehicle includes issuing a visual, audible or haptic warning.

Clause 60. The method of clause 54, further including transmitting a communication to the off-road vehicle following the lead vehicle using a vehicle-to-vehicle communication system, the communication including information relating to the follow time or the follow zone.

Clause 61. The method of clause 54, further including determining a speed of the off-road vehicle following the lead off-road vehicle based on data from the rearward-sensing sensor of the lead off-road vehicle.

Clause 62. The method of clause 61, wherein defining a first follow time includes considering the determined speed of the off-road vehicle following the lead vehicle.

Clause 63. The method of clause 54, wherein the lead off-road vehicle and the off-road vehicle following the lead off-road vehicle both comprise snowmobiles.

Clause 64. A method for detecting and warning off-road vehicle operators of out-of-sight vehicles, including: setting parameters of a first virtual vehicle zone associated with a first off-road vehicle; setting parameters of a second virtual vehicle zone associated with a second off-road vehicle; transmitting a communication signal from the second off-road vehicle, the communication signal including data describing the parameters of the second virtual vehicle zone of the second off-road vehicle; receiving at the first off-road vehicle the communication signal from the second off-road vehicle; determining, based on the received communication signal from the second off-road vehicle, including the data describing the parameters of the second virtual vehicle zone, and the parameters of the first virtual vehicles, that the first virtual vehicle zone and the second virtual vehicle zone overlap; and issuing a visual, audible or haptic proximity warning via a human-machine interface device of the first off-road vehicle.

Clause 65. The method of clause 64, further including transmitting a communication signal from the first off-road vehicle.

Clause 66. The method of clause 65, further including: receiving the communication signal from the first off-road vehicle at the second off-road vehicle; determining using a processor of the second off-road vehicle that the first and second virtual vehicle zones overlap; and issuing a visual, audible or haptic proximity warning via a human-machine interface device of the second off-road vehicle.

Clause 67. The method of clause 64, wherein transmitting a communication signal from the second off-road vehicle comprises transmitting a communication signal from the second off-road vehicle in a direction of location of the first off-road vehicle prior to a line-of-sight being available to the first and the second off-road vehicles.

Clause 68. The method of clause 64, wherein setting parameters of a first virtual vehicle zone associated with a first off-road vehicle includes determining a first virtual vehicle zone length, width and/or shape.

Clause 69. The method of clause 64, wherein determining that the first virtual vehicle zone and the second virtual vehicle zone overlap includes analyzing a location of the first off-road vehicle based on GPS data of the first off-road vehicle, a location of the second off-road vehicle based on GPS data of the second off-road vehicle, and the parameters of the first and second virtual-vehicle zones.

Clause 70. A method of changing an orientation of an off-road vehicle in a space-constrained environment, including: receiving at the vehicle a command to initiate a change of orientation of the off-road vehicle; detecting terrain objects in the space-constrained environment, using a sensor of the off-road vehicle; determining a location of the off-road vehicle relative to the terrain objects; determining locations of at least two pivot points, the at least two pivot points defining locations on which the off-road vehicle may pivot to accomplish the change in orientation; and displaying a graphical representation of the off-road vehicle, the terrain objects and the pivot points on a display screen of the off-road vehicle.

Clause 71. The method of clause 70, wherein the change of orientation is at least a 180° change in orientation.

Clause 72. The method of clause 70, wherein receiving at the vehicle a command to initiate a change of orientation of the off-road vehicle includes receiving a command from an operator of the vehicle via a touch-screen display of a human-machine interface of the off-road vehicle.

Clause 73. The method of clause 70, wherein determining locations of at least two pivot points includes analyzing one or more of: locations of the detected terrain objects, off-road vehicle characteristics, and a pathway forward of the off-road vehicle.

Clause 74. The method of clause 70, further including receiving input from an operator regarding user-selected pivot points, the user-selected pivot points being different than the at least two pivot points, and determining whether the user-selected pivot points would accomplish the change of orientation.

Clause 75. The method of clause 74, further including displaying on a display screen of the off-road vehicle whether the user-selected pivot points would accomplish the change of orientation.

Clause 76. The method of clause 70, further including: receiving steering angle data from a steering-angle sensor of the off-road vehicle at a computer processor of the off-road vehicle; determining, using the computer processor of the off-road vehicle, the steering angle of the off-road vehicle; and determining, using the computer processor of the off-road vehicle, a recommended steering angle of the off-road vehicle, wherein adjusting the steering system of the off-road vehicle to achieve the recommended steering angle of the off-road vehicle, followed by motion of the off-road vehicle, would result in the off-road vehicle arriving at the pivot point.

Clause 77. The method of clause 76, further including displaying on a display screen of the off-road vehicle a graphical representation of the steering angle of the off-road vehicle and a graphical representation of the recommended steering angle of the off-road vehicle.

Clause 78. The method of clause 70, further including determining a projected off-road vehicle pathway that if followed by the off-road vehicle would cause the off-road vehicle to arrive at one of the at least two pivot points.

Clause 79. The method of clause 78, further including displaying on a display screen of the off-road vehicle a graphical representation of the projected pathway.

Clause 80. The method of clause 79, wherein the graphical representation of the projected pathway is an arrow.

The embodiments above are intended to be illustrative and not limiting. Additional embodiments are within the claims. In addition, although aspects of the present invention have been described with reference to particular embodiments, those skilled in the art will recognize that changes can be made in form and detail without departing from the spirit and scope of the invention, as defined by the claims.

Persons of ordinary skill in the relevant arts will recognize that the invention may comprise fewer features than illustrated in any individual embodiment described above. The embodiments described herein are not meant to be an exhaustive presentation of the ways in which the various features of the invention may be combined. Accordingly, the embodiments are not mutually exclusive combinations of features; rather, the invention may comprise a combination of different individual features selected from different individual embodiments, as understood by persons of ordinary skill in the art.

Any incorporation by reference of documents above is limited such that no subject matter is incorporated that is contrary to the explicit disclosure herein. Any incorporation by reference of documents above is further limited such that no claims included in the documents are incorporated by reference herein. Any incorporation by reference of documents above is yet further limited such that any definitions provided in the documents are not incorporated by reference herein unless expressly included herein.

For purposes of interpreting the claims for the present invention, it is expressly intended that the provisions of Section 112, sixth paragraph of 35 U.S.C. are not to be invoked unless the specific terms “means for” or “step for” are recited in a claim.

What is claimed is:

1. A method of detecting and warning an operator of an off-road vehicle of objects in limited-visibility environments, comprising:
detecting a potentially-hazardous object within the vicinity of the vehicle, using a sensor of the vehicle;
transmitting data relating to the potentially-hazardous object to a vehicle processor;
determining whether the potentially-hazardous object is in a projected path of the vehicle or in a proximity zone of the vehicle; and
alerting the operator of the vehicle to the presence and location of the potentially-hazardous object when the potentially-hazardous object is in the projected path of the vehicle or in the proximity zone of the vehicle.

2. The method of claim 1, further comprising detecting a limited-visibility environment in a vicinity of the vehicle, the limited-visibility environment caused by airborne particles such as airborne dust, snow or rain.

3. The method of claim 2, wherein detecting airborne dust, snow or rain includes using a sensor of the vehicle other than the sensor of the vehicle used to detect the potentially-hazardous object.

4. The method of claim 2, wherein determining whether the potentially-hazardous object is in a projected path of the vehicle includes determining the projected path of the vehicle using a geolocation device of the vehicle.

5. The method of claim 1, wherein determining whether the potentially-hazardous object is in a proximity zone of the vehicle includes defining a proximity zone that defines a geographical region around the vehicle.

6. The method of claim 5, wherein defining a proximity zone that defines a geographical region around the vehicle includes defining a geographical area in front of, and behind, the vehicle.

7. The method of claim 1, further comprising displaying the potentially-hazardous object on a display screen of a human-machine interface of the vehicle, including displaying a map of the vicinity and displaying the potentially-hazardous object on the map.

8. A method of rearward tracking of off-road vehicles, comprising:
defining a first follow time for a first follow zone, the first follow time being a time duration required to traverse a length of the first follow zone;
detecting at a lead off-road vehicle an off-road vehicle following the lead vehicle using a rearwardly-sensing sensor on the lead off-road vehicle;
receiving speed sensor data from a speed sensor of the lead off-road vehicle, and determining a speed of the lead off-road vehicle based on the speed sensor data;
determining a follow time of the off-road vehicle following the lead off-road vehicle;
comparing the follow time of the off-road vehicle to the defined first follow time; and
issuing a warning via a human-machine interface (HMI) of the lead off-road vehicle, the warning indicating that the off-road vehicle following the lead vehicle is within the first follow zone.

9. The method of claim 8, wherein defining a first follow time for a first follow zone includes an operator manually defining the first follow time by interfacing with the HMI.

10. The method of claim 8, wherein defining a first follow time for a first follow zone includes a controller of the lead off-road vehicle defining the first follow time for a first follow zone based on the speed of the lead off-road vehicle.

11. The method of claim 8, wherein the first follow zone is determined based on the first follow time speed of the lead off-road vehicle.

12. The method of claim 8, further comprising transmitting a communication to the off-road vehicle following the lead vehicle using a vehicle-to-vehicle communication system, the communication including information relating to the follow time or the follow zone.

13. The method of claim 8, further comprising determining a speed of the off-road vehicle following the lead off-road vehicle based on data from the rearward-sensing sensor of the lead off-road vehicle.

14. The method of claim 13, wherein defining a first follow time includes considering the determined speed of the off-road vehicle following the lead vehicle.

15. A method for detecting and warning off-road vehicle operators of out-of-sight vehicles, comprising:
setting parameters of a first virtual vehicle zone associated with a first off-road vehicle;
setting parameters of a second virtual vehicle zone associated with a second off-road vehicle;
transmitting a communication signal from the second off-road vehicle, the communication signal including data describing the parameters of the second virtual vehicle zone of the second off-road vehicle;
receiving at the first off-road vehicle the communication signal from the second off-road vehicle;
determining, based on the received communication signal from the second off-road vehicle, including the data describing the parameters of the second virtual vehicle zone, and the parameters of the first virtual vehicles, that the first virtual vehicle zone and the second virtual vehicle zone overlap; and
issuing a visual, audible or haptic proximity warning via a human-machine interface device of the first off-road vehicle.

16. The method of claim 15, further comprising transmitting a communication signal from the first off-road vehicle.

17. The method of claim 16, further comprising:
receiving the communication signal from the first off-road vehicle at the second off-road vehicle;
determining using a processor of the second off-road vehicle that the first and second virtual vehicle zones overlap; and
issuing a visual, audible or haptic proximity warning via a human-machine interface device of the second off-road vehicle.

18. The method of claim 15, wherein transmitting a communication signal from the second off-road vehicle comprises transmitting a communication signal from the second off-road vehicle in a direction of location of the first off-road vehicle prior to a line-of-sight being available to the first and the second off-road vehicles.

19. The method of claim 15, wherein setting parameters of a first virtual vehicle zone associated with a first off-road vehicle includes determining a first virtual vehicle zone length, width and/or shape.

20. The method of claim 15, wherein determining that the first virtual vehicle zone and the second virtual vehicle zone overlap includes analyzing a location of the first off-road vehicle based on GPS data of the first off-road vehicle, a location of the second off-road vehicle based on GPS data of the second off-road vehicle, and the parameters of the first and second virtual-vehicle zones.
